(19) United States
(12) Patent Application Publication
(10) Pub. No.: US 2026/0177355 A1
(43) Pub. Date: Jun. 25, 2026

(54) OPERATING SYSTEM FOR GUIDED WEAPON SYSTEMS

(71) Applicant: Aeon Industrial Inc., Austin, TX (US)

(72) Inventors: Carlos Guillermo Parodi, Austin, TX (US); Lary Ray Cotten, Austin, TX (US); Joseph Cieslik, Austin, TX (US); Gavin Whelan, Austin, TX (US); Garth Whelan, Austin, TX (US); John Wiggins, Austin, TX (US); Harpo Roeder, Austin, TX (US)

(21) Appl. No.: 19/327,945

(22) Filed: Sep. 12, 2025

Related U.S. Application Data
(60) Provisional application No. 63/694,342, filed on Sep. 13, 2024.

(51) Int. Cl. F41G 7/22; B64U 10/25; B64U 40/10; B64U 50/00

(52) U.S. Cl. CPC F41G 7/2253; B64U 10/25; B64U 40/10; B64U 50/00; F41G 7/2206; B64U 2201/10

(57) ABSTRACT

Methods, systems, and apparatus, including computer programs encoded on a storage device, for guiding weapon systems to targets are disclosed. A method includes obtaining sensor data from one or more sensors mounted to a weapon system; providing the sensor data as input to a target model, the target model being an artificial intelligence model trained to detect a particular type of object within a set of sensor data from one or more particular types of sensors and to provide output that is decipherable by flight control systems to control navigation operations; obtaining output data from the target model; providing the output data from the target model to a flight control system of the weapon system; and controlling operation of one or more control surfaces of the weapon system, responsive to the output data to control a trajectory of the weapon system.

### CROSS-REFERENCE TO RELATED APPLICATION

This application claims the benefit of the filing date of U.S. Provisional Application No. 63/694,342, filed on Sep. 13, 2024. The contents of U.S. Application No. 63/694,342 are incorporated herein by reference in their entirety

### TECHNICAL FIELD

The present specification relates to an operating system for guided weapon systems such as ordnance munitions.

### BACKGROUND

A guided weapon system can be launched from a platform toward a target. The platform can be, for example, a tank, an aircraft, or a missile platform. The weapon system can be controlled to perform a number of actions. The weapon system can be a steerable weapon system that is able to actively alter its trajectory as it travels the distance to the target. In some examples, the weapon system can be steered or navigated based on its location. In some examples, the weapon system includes a payload for causing damage to the target.

### SUMMARY

In general, the present disclosure relates to an operating system for guided weapon systems. The disclosed operating system is responsible for the entire lifecycle of a weapon system from configuration at the factory to a terminal effect on a target. The operating system can be loaded into a weapon system at the factory and acts as the firmware or interface layer between the underlying hardware such as actuators and sensors as well as a higher level operating system for tasks like autonomous navigation. The operating system handles configuration files that inform the firmware layer of the hardware that is present on the weapon system. Additionally, the operating system handles the configuration, loading/storage of machine learning (ML) models, and the processing pipeline of the model from sensor data to control loop to output.

The operating system handles guidance, navigation, and control for the entire weapon system. The operating system detects targets using the sensor modalities that are present and configured on the weapon system. The operating system navigates the weapon system through the environment using direct guidance, inertial measurement units, inertial navigation, global positioning system (GPS), global navigation satellite system (GNSS), or any combination thereof. The operating system controls the navigation of the weapon system using configured control loops and other programmed means.

The operating system can maintain track on targets using target sensors mounted to the weapon system. The operating system can implement Kalman filters, reidentification machine learning models, and other methods in the case that a track is lost. For example, a target track can be lost when the target passes behind a tree, cloud, or other obstruction.

The operating system can have a built-in sensor fusion capability to be able to use more than one sensor and modality at the same time for guidance, navigation, and control. In some cases, the operating system can autonomously decide which sensor is providing the highest confidence of target detection and tracking. In some cases, the operating system employs user input to cue the system to use a particular sensor and/or to weight sensor data from one sensor more than sensor data from another sensor.

The operating system can manage all actions the weapon system takes during the terminal phase of flight. This can include deploying countermeasures such as jammers and chaff. The operating system can deploy countermeasures in order to defend against targets such as battle tanks using active protection systems, or ships using radar controlled guns.

The operating system can make decisions regarding the terminal guidance phase autonomously. The operating system can select an aspect of the target to engage, and maneuvering towards the selected aspect. For example, when targeting an armored vehicle, the system can determine to use a top attack or direct attack profile. When targeting a surface vessel, the operating system can identify different parts of the vessel (e.g., bridge, fuel tank, engine room, radar mast, etc.) and can select which parts to engage based on a preprogrammed list of priorities. The operating system can do an autonomous battle damage analysis to ensure the operating system does not hit an area that is already adequately damaged or destroyed. The operating system can use deep learning computer vision to determine the weak points of a target such as parts of a tank that are not protected by explosive reactive armor.

The operating system is responsible for controlling the timing, triggering, and safety of the payload that is equipped on the weapon system, whether explosive or otherwise. This can include measuring a distance to the target to determine the optimal firing of a shaped charge, or firing multiple shaped charges precisely, to defeat the target's reactive armor. This can also include turning the safety on and off of the payload to ensure a warhead does not detonate prematurely and injure operators.

The operating system can manage updates to models and configuration files. Model updates, software updates, and configuration updates can be performed with an issued key server. The issued key server can be a tamper resistant computer system running custom update software. Updates can use a two layer encrypted handshake. The first layer can use a public-key cryptography as part of a signed update certificate. The second layer can use a hardware encryption device such as a Trusted Platform Module to ensure the underlying hardware and software on both the weapon system and the update server have not been tampered with.

The operating system can attempt to detect physical tampering and can delete itself from the weapon hardware in situations in which the weapon misses or the platform the weapon is attached to is lost or stolen. The deletion encompasses the operating system, configuration files, ML models, and control loops. In the event that the weapon system misses the target, the operating system determines actions to be taken, such as triggering the warhead so as not to leave unexploded ordnance on the battlefield.

For export safety and anti-proliferation, the operating system can be configured with several compliance features. For example, a compliance feature may require that the weapon system is physically checked in and connected to the key server at scheduled intervals or the operating system will shut down. In another example, a GPS geofence is implemented such that the weapon system will stop working if the operating system detects that the weapon system has left a designated area of operation. In another example, a weapon system operator authenticates into the system using a password, pattern, biometric pattern, and/or physical device such as a radio frequency identification (RFID) card.

The operating system can be integrated into joint battle management systems. The operating system can communicate with other systems or platforms using a physical connection (e.g., wires, fiber optics, hardpoints), radio, light-based communications, and other wired and wireless methods. The operating system can receive and process Cursor on Target messages and similar targeting data in a networked battlefield environment. The operating system is capable of swarming multiple munitions together for target deconfliction. In an example in which multiple different weapon systems detect multiple different targets, networked or swarm target deconfliction solves the problem of target overlap between the multiple weapon systems.

In general, innovative aspects of the subject matter described in this specification can be embodied in a non-transitory computer readable storage medium having stored thereon processor-executable software instructions configured to cause a processor to perform the actions of any of the implementations.

In general, innovative aspects of the subject matter described in this specification can be embodied in a system, including: at least one processor; and a data store coupled to the at least one processor having instructions stored thereon which, when executed by the at least one processor, causes the at least one processor to perform the actions of any of the implementations.

Other implementations of the above aspects include corresponding systems, apparatus, and computer programs configured to perform the actions of the methods, encoded on computer storage devices. The details of one or more implementations of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1A is a diagram of an example guided weapon system in accordance with implementations of the present disclosure.

FIG. 1B is a flow diagram of an example process for operating a guided weapon system in accordance with implementations of the present disclosure.

FIG. 1C is a diagram of an example power supply system for a guided weapon system in accordance with implementations of the present disclosure.

FIG. 2A is a diagram of an example system for tracking targets using multiple sensors in accordance with implementations of the present disclosure.

FIG. 2B is a flow diagram of an example process for tracking targets using multiple sensors in accordance with implementations of the present disclosure.

FIG. 2C is a diagram of an example system for tracking targets using freeze frame target acquisition in accordance with implementations of the present disclosure.

FIG. 2D is a flow diagram of an example process for tracking targets using freeze frame target acquisition in accordance with implementations of the present disclosure.

FIG. 3A is a diagram of an example system for terminal effect control of a weapon system in accordance with implementations of the present disclosure.

FIG. 3B is a flow diagram of an example process for terminal effect control of a weapon system in accordance with implementations of the present disclosure.

FIGS. 4A to 4D show example stages of a process for target tracking recovery including adjusting target sensors in accordance with implementations of the present disclosure.

FIGS. 4E to 4H show example stages of a process for target tracking recovery including selectively searching sensor data in accordance with implementations of the present disclosure.

FIG. 4I is a flow diagram of an example process for target tracking recovery in accordance with implementations of the present disclosure.

FIG. 5 is a flow diagram of an example process for assigning multiple weapon systems to multiple targets in accordance with implementations of the present disclosure.

FIG. 6 is a flow diagram of an example process for safeguarding weapon systems in accordance with implementations of the present disclosure.

Like reference numbers and designations in the various drawings indicate like elements.

### DETAILED DESCRIPTION

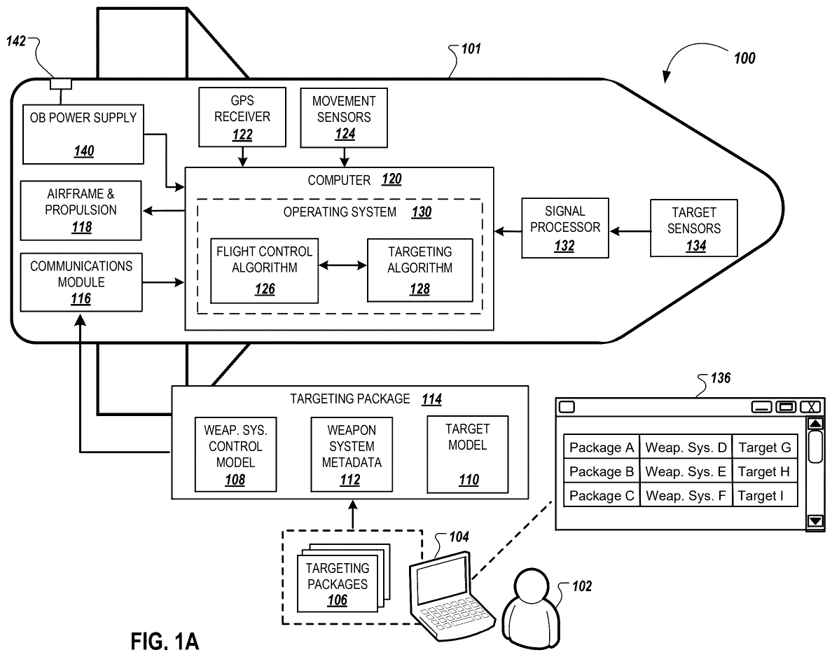

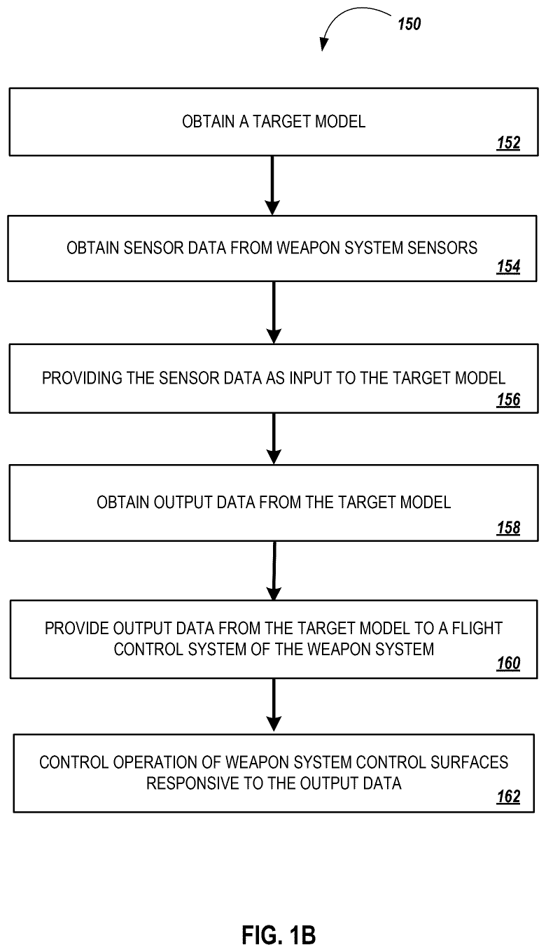

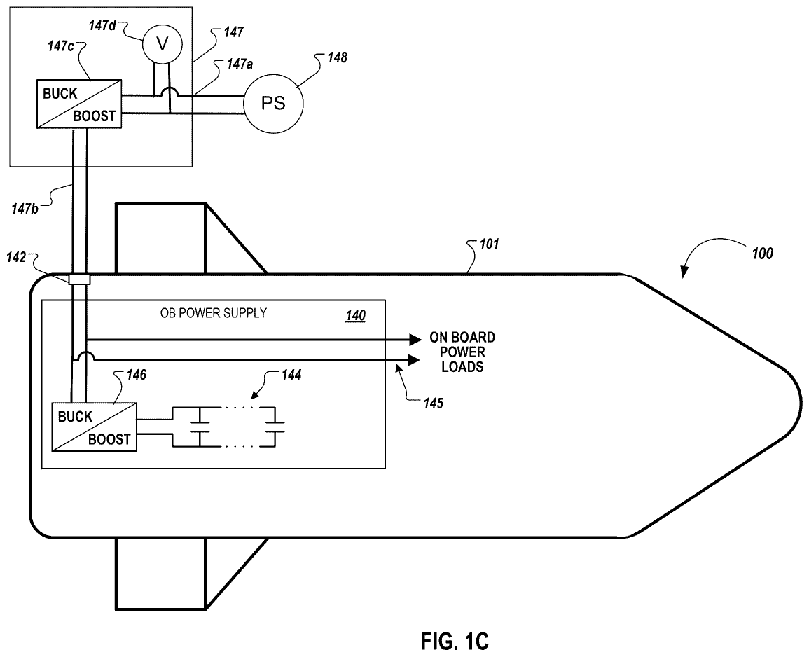

This disclosure generally describes computer-implemented methods, software, and systems for guiding weapon systems to targets. FIG. 1A is a diagram of an example guided weapon system 100. Guided weapon systems can include missiles such as air-to-air missiles, surface-to-air missiles, surface-to-surface missiles, and air to surface missiles. Guided weapon systems can also include rockets, guided bombs, glide bombs, and torpedoes.

The weapon system 100 includes one or more computers (e.g., computer 120). The computer 120 runs an operating system 130. In general, the operating system 130 operates to reduce the difference between multiple quantities (e.g., the location of the weapon system, the location of a target). The targeting algorithm 128 tracks the target and generates data representing the location of the target. The operating system 130 can implement one or more machine learning models for detecting, identifying, and tracking a target, for guiding the weapon system to the target, for controlling maneuvers of the weapon system, or any combination thereof, as further described below. To perform targeting and guidance operations, the operating system 130 implements a flight control algorithm 126 and a targeting algorithm 128. The targeting algorithm 128 is part of a targeting system that is housed within a weapon system body 101 of the weapon system 100, e.g., a fuselage of a guided missile, rocket, or bomb.

A guided weapon is a weapon such as a projectile that can alter its flight path after it leaves the launching device to effect target intercept. A guided weapon includes components such as inertial sensors, targeting sensors, radio receivers, autopilot, and a guidance computer. The flight path of a guided weapon is adjusted by using movable control surfaces, thrust vectoring, side thrusters, or some combination of these methods.

In some cases, a target's location is not known precisely when the weapon system is launched. To intercept the target, the weapon system senses the target in real time and responds to changes in the target location, direction, and speed. Homing guidance can be used to accomplish the intercept. Homing guidance is a type of guidance in which an onboard sensor, or seeker, provides target data on which guidance decisions are based. Target homing, or seeking, is performed by a guided weapon that uses a seeker to detect and track a target and travel towards the target on an intercept course.

Guided weapon system targeting includes target detection, localization, identification, tracking, and engagement. To detect a target, a predetermined area can be searched for a target using target sensors, and the target's presence is detected in the sensor data. This can be accomplished actively, by sending energy out into the medium and waiting for the reflected energy to return, as in radar, and/or passively, by receiving energy being emitted by the target. Localization is performed by measuring the target's position more accurately, and by a series of such measurements, estimating the target's motion relative to the weapon system. This can be accomplished by repeatedly determining the target's range, bearing, depth, and/or elevation. To identify the target, the target can be classified according to its type, number, size and identity. In some examples, an individual target is identified from a multi-target group.

To track the target, updates as to the target's position and its velocity relative to the weapon system can be estimated continuously. This information can be used to predict the target's future position and a weapon intercept point so the weapon can be accurately aimed and controlled. The weapon system can be aimed at the target by movable control surfaces. Feedback provides the system with the difference, or error, between where the seeker is pointing and where the target is actually located. The system processes the error and through a series of electro-mechanical devices moves the weapon system in the proper direction and at a rate such that the error is reduced. It is the goal of any tracking system to reduce this error to zero, or minimum. Engaging a target includes a payload being delivered to the vicinity of the target. The weapon system can engage the target by intercepting the target and activating the payload upon intercept, prior to intercept, or after intercept.

The targeting system also includes one or more target sensors 134 for seeking the target. A guided weapon system can use passive seeking, semi-active seeking, or active seeking. A passive seeker receives energy that emanates from a target. A semi-active guidance system illuminates the target by directing a beam of energy from the launch platform or from an adjacent location at the target. The passive seeker in the weapon system then tracks the target using the energy reflected from the target. An active seeker illuminates the target using a transmitter on the weapon system.

The targeting system includes a signal processor 132. The signal processor 132 processes signals generated by the target sensors 134. The signal processor 132 can be, for example, a digital signal processor that converts or transforms the sensor data into digital data in a format suitable for input to the targeting algorithm 128. The signal processor 132 outputs the sensor data to the operating system 130 running on the computer 120.

In some examples, the sensor data includes two-dimensional data representing a location of a target (e.g., range, bearing). In some examples, the sensor data includes three-dimensional data representing a three-dimensional data representing the location of the target (e.g., range, bearing, elevation).

In some examples, the sensor data includes imaging data represented by an array of pixels. Each pixel is associated with a location within a field of view of the sensor. The location can be, for example, a two-dimensional coordinate value (e.g., in Cartesian or polar coordinates) relative to the field of view. Each pixel is associated with a pixel value. The pixel value can be, for example, a HSV (Hue, Saturation, Value) value, an RGB (red, green, blue) value, a CMYK (Cyan, Magenta, Yellow, Black) pixel value, a YIQ (luminance, chrominance) pixel value, or a grayscale pixel value.

In some implementations, a machine learning model is a deep learning model that employs multiple layers of models to generate an output for a received input. A deep neural network is a deep machine learning model that includes an output layer and one or more hidden layers that each applies a non-linear transformation to a received input to generate an output. In some cases, the neural network may be a recurrent neural network. A recurrent neural network is a neural network that receives an input sequence and generates an output sequence from the input sequence. In particular, a recurrent neural network uses some or all of the internal state of the network after processing a previous input in the input sequence to generate an output from the current input in the input sequence. In some other implementations, the machine learning model is a convolutional neural network. In some implementations, the machine learning model is an ensemble of models that may include all or a subset of the architectures described above.

In some implementations, the machine learning model can be a feedforward autoencoder neural network. For example, the machine learning model can be a three-layer autoencoder neural network. The machine learning model may include an input layer, a hidden layer, and an output layer. In some implementations, the neural network has no recurrent connections between layers. Each layer of the neural network may be fully connected to the next, there may be no pruning between the layers. The neural network may include an ADAM optimizer, or any other multi-dimensional optimizer, for training the network and computing updated layer weights. In some implementations, the neural network may apply a mathematical transformation, such as a convolutional transformation, to input data prior to feeding the input data to the network.

In some implementations, the machine learning model can be a supervised model. For example, for each input provided to the model during training, the machine learning model can be instructed as to what the correct output should be. The machine learning model can use batch training, training on a subset of examples before each adjustment, instead of the entire available set of examples. This may improve the efficiency of training the model and may improve the generalizability of the model. The machine learning model may use folded cross-validation. For example, some fraction (the “fold”) of the data available for training can be left out of training and used in a later testing phase to confirm how well the model generalizes. In some implementations, the machine learning model may be an unsupervised model. For example, the model may adjust itself based on mathematical distances between examples rather than based on feedback on its performance.

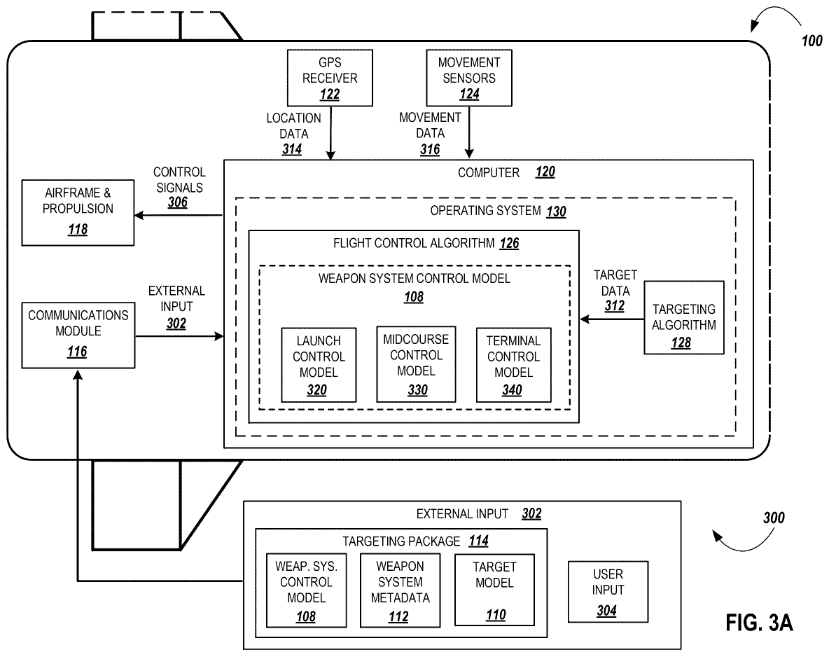

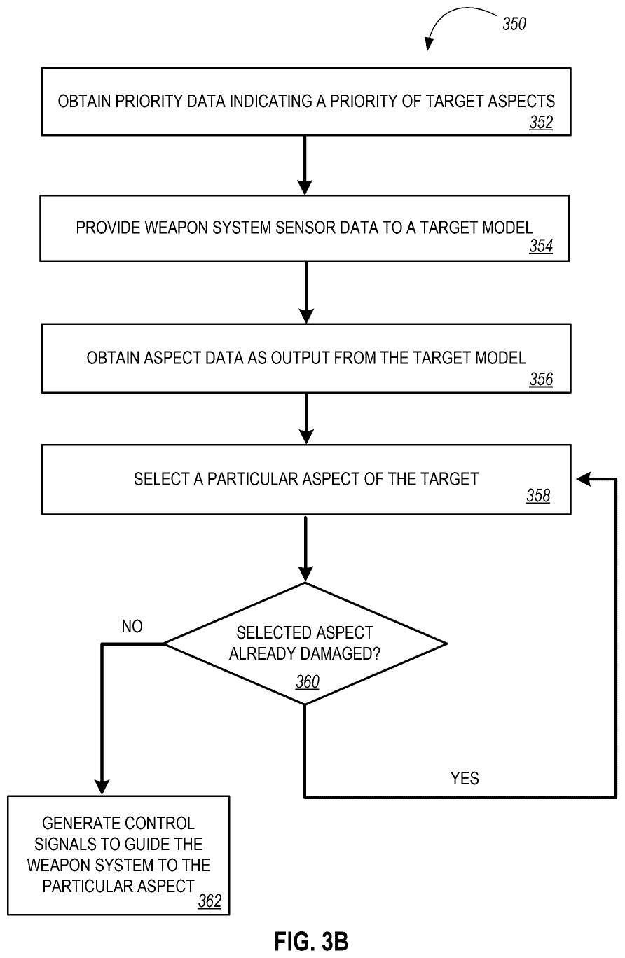

Referring to FIG. 3A, the targeting algorithm 128 outputs target data 312 to the flight control algorithm 126. The flight control algorithm 126 is part of a flight system that is housed within the weapon system body 101. The flight system also includes an airframe and propulsion 118 of the weapon system 100. The airframe and propulsion 118 can include control surfaces for controlling a speed and direction of travel of the weapon system. The control surfaces can include, for example, wings, fins, rudders, ailerons, elevators, tails, stabilizers, foils, or any combination of these. The flight system can include controllers for the control surfaces that are mechanically coupled to the control surfaces.

Referring again to FIG. 3A, the flight control algorithm 126 receives the target data 312 and generates control signals 306 configured to drive the weapon system from its current position towards the target. The flight control algorithm 126 is thus configured to control operation of the control surfaces responsive to the output data from the targeting algorithm 128 to control a trajectory of the weapon system 100.

The computer 120 outputs the control signals 306 to the airframe and propulsion 118 of the weapon system 100. In some examples, the control signals 306 include electrical steering signals that adjust the control surfaces in order to steer the weapon system 100 towards the target. In some examples, the control signals 306 cause a change in position of the control surfaces of the weapon system 100. In some examples, the computer 120 can output control signals 306 that change settings of the ignition, control servo unit, propulsion engine, and/or other components of the weapon system 100. Functions performed by the operating system 130 to drive the weapon system 100 to the target are described in greater detail with reference to FIG. 1B.

The weapon system 100 can include a GPS receiver 122, movement sensors 124, or both. The GPS receiver 122 communicates with GPS satellites to determine a location of the weapon system 100. Referring to FIG. 3A, the GPS receiver 122 outputs location data 314 to the computer 120. The location data 314 can include, for example, a set of GPS coordinates indicating a current position of the weapon system 100.

The movement sensors 124 can include, for example, accelerometers, gyroscopes, altimeters, inertia sensors, or any combination of these. Referring to FIG. 3A, the movement sensors 124 output movement data 316 to the computer 120. The movement data 316 can include, for example, accelerometer data, gyroscope data, altitude data, inertial data, or any combination of these.

The operating system 130 can determine a position and/or trajectory of the weapon system 100 based on the movement data. For example, the operating system 130 can determine the altitude, speed, acceleration, 2-dimensional or 3-dimensional direction of travel, and/or turning rate based on the movement data.

In some implementations, the weapon system 100 includes a communications module 116 that enables the weapon system 100 to communicate with external computing systems. For example, the weapon system 100 can communicate with a computing device 104 through the communications module 116. The communications module 116 can send and receive information over one or more wired or wireless networks. Referring to FIG. 3A, the communications module 116 can receive external input 302 and provide the external input 302 to the computer 120.

The computing device 104 stores one or more targeting packages 106. Each targeting package 106 can include any combination of the following: a weapon control system model, weapon system metadata, a target model. In the example of FIG. 1A, the targeting packages 106 include a targeting package 114 that is provided to the weapon system 100. The targeting package 114 includes a weapon system control model 108, weapon system metadata 112, and the target model 110.

In some examples, one of the targeting packages 106 is loaded into the computer 120 at a given time. In some examples, more than one of the targeting packages 106 are loaded into the computer 120 at a given time. For example, the targeting packages 106 can include a first targeting package including a target model for a first type of target, and a second targeting package including a target model for a second, different type of target. The first targeting package and the second targeting package can each include a weapon system control model 108 and weapon system metadata 112 for the particular type of the weapon system 100.

The targeting package 114 can be loaded into the computer 120 prior to deployment of the weapon system 100. In an example scenario, the weapon system 100 is an airborne weapon system that is carried by an aircraft, and the targeting package 114 is loaded into the computer 120 after takeoff of the aircraft, and before the weapon system 100 is launched from the aircraft. In another example, scenario, the weapon system 100 is an airborne weapon system that is carried by an aircraft, and the targeting package 114 is loaded into the computer 120 prior to takeoff of the aircraft. The computer 120 includes a data store that stores the targeting package 114 after the targeting package 114 is received by the computer 120.

In some examples, the targeting package 114 is uploaded into the computer 120 prior to loading the weapon system 100 onto a platform. In some examples, the targeting package 114 is loaded into the computer 120 during an update to the operating system. In some examples, the targeting package 114 is uploaded into the computer 120 prior to a mission, and the targeting package 114 includes one or more target models 110 that are specific to a target or set of targets that is an objective of the mission.

The computing device 104 can present a user interface 136 showing information about the targeting packages 106. Each targeting package of the targeting packages 106 can be specific to a particular weapon system and to a particular target. In some examples, a targeting package is specific to a set of multiple targets. In the example of FIG. 1A, the user interface 136 shows information about Package A, Package B, and Package C. Package A is for Weapon System D to engage Target G. Package B is for Weapon System E to engage Target H. Package C is for Weapon System F to engage Target I.

In some examples, each targeting package of the targeting packages 106 is a specifically trained AI model that is focused on identifying a single type of target in a particular region. For example, Package A can be trained to identify a first model of tank in a forest region (Target G). Package B can be trained to identify a second model of tank in a desert region (Target H). The targeting package 114 selected and uploaded to the computer 120 is specific to the type of the weapon system 100 and the target or targets to be engaged by the weapon system 100.

By uploading the targeting package 114 for a specific weapon system and target, instead of for multiple different weapon systems and targets, the data processing and memory required can be reduced. Therefore, the weapon system 100 can perform guidance, navigation, and control operations with a smaller computer, compared to a weapon system that stores many different targeting packages for many different targets.

The computing device 104 can provide the targeting package 114 to the weapon system 100 through the communications module 116. In some examples, the computing device 104 can provide the targeting package 114 in response to a user 102 selecting the targeting package 114 from the targeting packages 106.

The target model 110 can be an artificial intelligence (AI) model that is trained to detect a particular type of object within sensor data received from target sensors. In some examples, the target model 110 includes multiple machine learning models. For example, the target model 110 can include a first machine learning model that is trained to identify a target using a first type of sensor data (e.g., electro-optical sensor data), and a second machine learning model that is trained to identify a target using a second type of sensor data (e.g., thermal sensor data).

In some examples, the target model 110 outputs data indicating a confidence of detecting the particular type of object. The output of the target model can include a confidence value indicating a level of confidence that an object within the sensor data is the particular type of object. For example, the target model 110 can be trained to detect a specific class of armored vehicle, and can output data indicating the confidence of detection of the specific class of armored vehicle. In general, the target model 110 can be trained to detect targets of specific classes, models, colors, camouflage patterns, sizes, shapes, and/or other characteristics.

In some examples, the target model 110 provides output data that is decipherable by flight control systems. For example, the target model 110 can provide output data that indicates a location of a target relative to the weapon system 100 and/or relative to the field of view of the target sensors 134.

The weapon system control model 108 is a model that is specific to the weapon system 100. The weapon system control model 108 generates control signals for maneuvering the weapon system 100. The control signals control operations of the airframe and propulsion 118 of the weapon system 100. In some examples, the weapon system 100 does not have propulsion, such as a weapon system 100 that is a glide bomb.

In some examples, the weapon system control model 108 is an AI model that is trained to determine control surface operations to maneuver the weapon system to the target based on the target location and the weapon system location. In some examples, the weapon system control model 108 includes one or more machine learning models that can learn over time based on observed behavior. For example, the machine learning model can learn, over time, adjustments to make to control surfaces of the weapon system 100 in order to efficiently guide the weapon system to the desired path indicated by the output of the targeting algorithm 128.

In some examples, the weapon system control model 108 is a rule-based model. A rule-based model uses pre-defined rules to generate output. For example, the flight control algorithm 126 can use a rule-based weapon system control model 108 to process output data from the targeting algorithm 128. The weapon system control model 108 can process the output data using predetermined formulas for relationships between movements of control surfaces of the weapon system 100, and maneuvers of the weapon system 100. For example, a formula may specify a relationship between a desired change in altitude of the weapon system 100 and a degree of change of position of one or more control surfaces of the weapon system airframe.

In some examples, the weapon system control model 108 uses a control loop such as a proportional-integral-derivative (PID) control loop. A PID controller continuously calculates an error value as the difference between a desired setpoint and a measured process variable and applies a correction based on proportional, integral, and derivative terms. For example, the setpoint can be a maximum specified distance between a target and a center of a sensor field of view. The weapon system control model 108 can apply a correction to control surfaces of the weapon system 100 by generating control signals that reduces the distance between the target and the center of the sensor field of view to be less than the maximum specified distance. Processes for maneuvering the weapon system based on output generated by the targeting algorithm 128 are described in greater detail with reference to FIG. 1B.

The weapon system metadata 112 includes information about the weapon system 100. The weapon system metadata 112 can include information such as the number and types of target sensors 134 on the weapon system 100, the number and types of munitions on the weapon system 100, and operational limits of the weapon system (e.g., maximum speed, maximum altitude, maximum depth, turn radius at various speeds).

The weapon system 100 includes an onboard power supply system 140. The onboard power supply system 140 provides power to the computer 120 and other electrical loads on the weapon system 100, e.g., servo motors, propulsion controllers, sensors 122, 124, 134, communication module 116, and signal processor 132. IG. 1C is a more detailed diagram of the power supply system 140.

The power supply system 140 includes a capacitor bank 144 housed within the weapon system body 101. The capacitor bank 144 can include a bank of one or more capacitors or supercapacitors. The capacitor bank 144 provides electric power to power loads of the weapon system 100 through a regulated power bus 145. The capacitor bank 144 can include one or more capacitors that together provide from 5 F to 20 F (Farads) of capacitance. For example, the capacitor bank 144 can include five to fifteen 1 F capacitors wired in parallel. In some implementations, the capacitor bank 144 can have a total capacity of between 5 F to 20 F. For example, the capacitor bank 144 can have a total capacity 7 F, 8 F, 9 F, or 10 F.

A boost/buck converter 146 can be connected between the output of the capacitor bank 144 and the regulated power bus 145. The boost/buck converter 146 regulates the output of the capacitor bank 144 to maintain a consistent voltage on the regulated power bus 145, e.g., 12V, 15V, 18V, 24V. In some implementations, the capacitor bank 144 is charged to a higher voltage than the operating voltage of the regulated power bus 145. For example, the capacitor bank 144 can be charged to a voltage of 20V, 22V, 24V, 28V, or 30V. In such implementations, the boost/buck converter 146 is configured to reduce the output voltage of the capacitor bank 144 to the operating voltage of the regulated power bus 145 for supplying power to the onboard loads, e.g., when the systems'power flow is from the capacitor bank to the regulated power bus 145

The regulated power bus 145 and the capacitor bank 144 are also connected to a charging connection or charging terminal 142. The charging connection 142 can be used to power the weapon system 100 prior to launch and/or to charge the capacitor bank 144. Charging can be accomplished with a capacitor charging system 147. The charging system 147 includes an input connection 147a, an output connection 147b, and a boost/buck converter 147c. In some implementations, the charging system 147 includes a voltage sensor 147d. In some implementations, the charging connection 142 is electrically connected to the regulated power bus 145 and indirectly connected to the capacitor bank 144 through the boost/buck converter 146 (as depicted in FIG. 1C). In some implementations, the charging connection 142 is electrically connected to the capacitor bank 144, and indirectly connected to the regulated power bus 145 through the boost/buck converter 146.

The charging system 147 is configured to convert input voltage from an external power source 148 to an operating voltage of the power supply system 140. For example, the capacitor charging system 147 can be configured to operate at input voltages ranging between 5V-40V; 9V-36V; or 9-24V, and to generate output voltages ranging between 12V, 15V, 18V, 22V, 24V, 28V, or 30V. The output voltage of the capacitor charging system 147 corresponds with the operating voltage of the regulated power bus 145. In some implementations, the output voltage of the capacitor charging system 147 corresponds with the operating (e.g., desired charged voltage) of the capacitor bank 144. The charging system 147 can control operation of the boost/buck converter 147c to adapt to different external power supplies 148. For example, this allows users to charge the weapon system 101 using output voltage from a portable device (e.g., a radio battery) or from a vehicle (e.g., a vehicle battery). For example, the charging system can detect the input voltage from the external power supply 148 and control operation of the boost/buck converter 147c to generate a voltage output at the output connection 147b that corresponds with the operating voltage of the power supply system 140. For example, the boost/buck converter 147c converts the input voltage of the capacitor charging system 147 to correspond with the operating voltage of the regulated power bus 145 or the capacitor charging system 144, e.g., depending on the wiring configuration of the onboard power supply 140 (discussed above). In some implementations, if the charging connection 142 is directly wired to the regulated power bus 145, the boost/buck converter 146 is configured to boost the voltage input from the regulated power bus 145 to charge the capacitor bank 145. For example, the boost/buck converter 146 can be configured to detect direction of power flow, e.g., detect an input at the charging connection 142 and adjust its operation to supply a charging current to the capacitor bank 144.

In some implementations, the charging connection 142 can be used as a discharging connection as well. For example, it may be desirable to store the weapons system 100 in an inert condition with no power. The charging connection 142 can be used to drain the power from the capacitor bank 144 and store the weapon system 100 in an inert condition. In some implementations, the use of a capacitor bank 144 for onboard power is advantageous because it allows for more rapid charging and discharging as compared to a chemical battery. Moreover, capacitors can be completely discharged without adverse effect on their ability to store energy, unlike a chemical battery.

FIG. 1B is a flow diagram of an example process 150 for operating a guided weapon system in accordance with implementations of the present disclosure. The process 150 can be performed by a computing system including one or more computers, such as the computer 120. Some of the steps of the process 150 can be performed prior to deployment of a weapon system. Some of the steps of the process 150 can be performed during a deployment of a weapon system, such as during a flight of an airborne weapon system.

The process 150 includes obtaining a target model (152). For example, the weapon system 100 can obtain the target model 110 as part of the targeting package 114. The target model 110 is an artificial intelligence (AI) model that is trained to detect a particular type of object within sensor data generated by the target sensors. The target model 110 is trained to provide output that is decipherable by flight control systems to control navigation operations.

The process 150 includes obtaining sensor data from weapon system sensors (154). The sensors can be mounted to a weapon system. In some examples, the sensors are housed within a weapon system body. The weapon system sensors can be, for example, the target sensors 134 of the weapon system 100. The target sensors 134 generate sensor data that is processed by the signal processor 132 and provided to the operating system 130 running on the computer 120. The sensor data can include radar sensor data, infrared sensor data, imaging sensor data, visible light sensor data, lidar sensor data, ultraviolet sensor data, x-ray sensor data, audio sensor data, ultrasonic sensor data, magnetic sensor data, or any combination thereof. The radar sensor data can include active sensor data, passive sensor data, or both.

The process 150 includes providing the sensor data as input to the target model (156). For example, the operating system 130 can provide the sensor data as input to the target model 110. In some examples, the operating system 130 includes a target control system that is in electrical communication with the target sensors 134. The target control system stores the target model 110 as part of the targeting algorithm 128.

The process 150 includes obtaining output data from the target model (158). In some implementations, the target model 110 outputs a relative location of the target within a field of view of a target sensor. In such implementation, the operating system can convert the output into data that is actionable by the flight control systems (e.g., target bearing, range, bearing rate, etc.). For example, the targeting algorithm 128 can use the target model 110 to generate target data 312, and can output the target data 312 to the flight control algorithm 126.

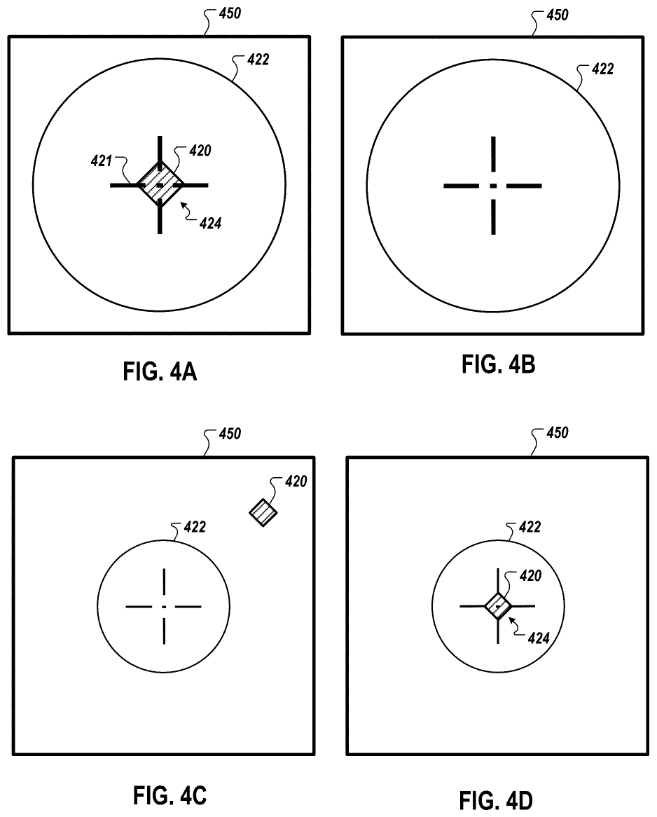

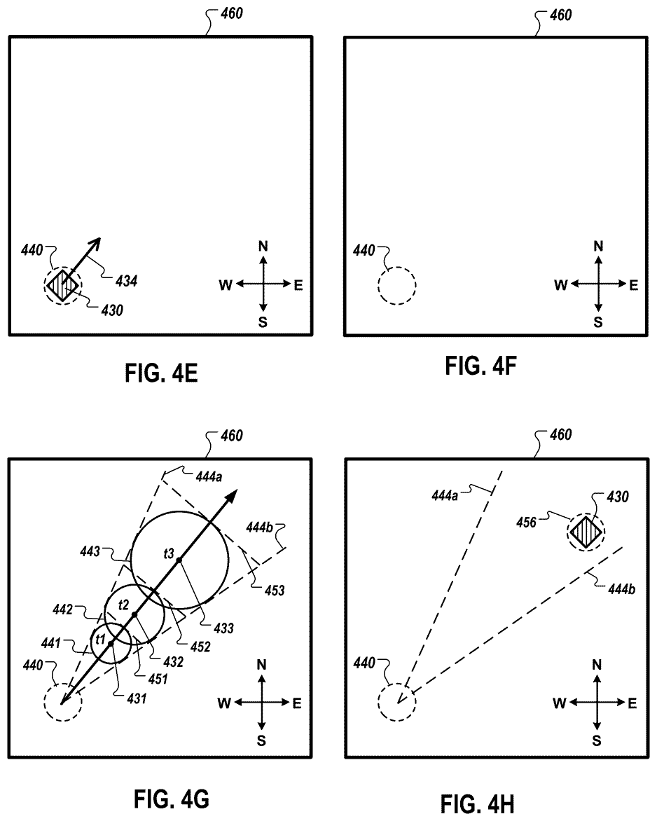

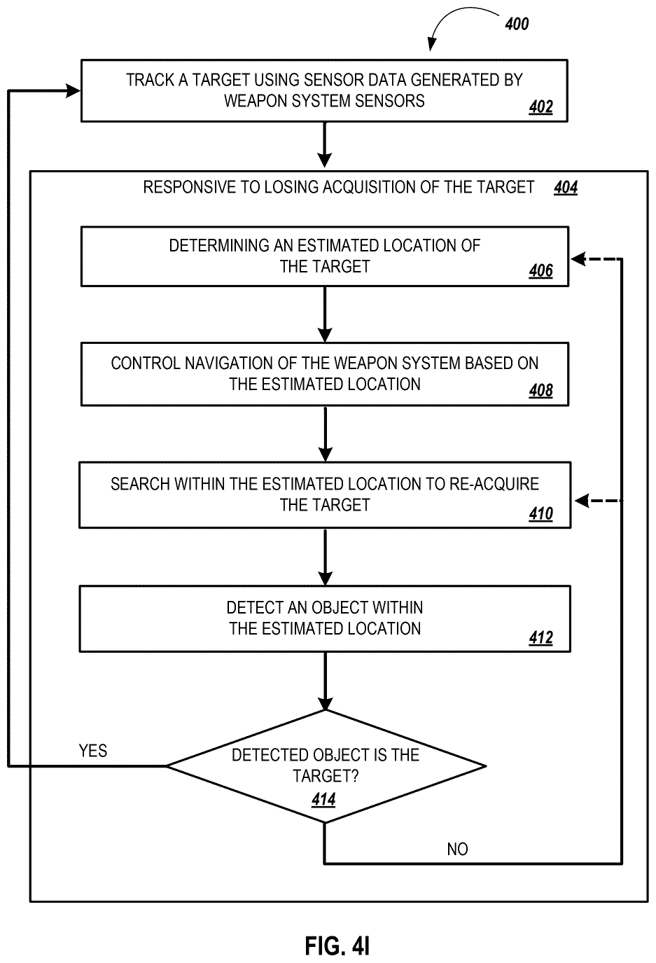

In some examples, the output data from the targeting algorithm 128 includes navigation instructions indicating a location of an object relative to a location or an orientation of the weapon system. For example, referring to FIG. 4A, a target sensor has a field of view 450. A cursor 421 is located at a center 424 of the field of view 450. The operating system 130 can be configured to maneuver the weapon system towards a target 420 by maintaining the target 420 at the location of the cursor 421. The targeting algorithm 128 can output, to the flight control algorithm 126, data indicating a distance and/or direction between the cursor 421 and the target 420. The distance can be represented, for example, as a number of sensor pixels between the center of the cursor 421 and the center of the target 420 in the field of view 450.

In some examples, the output data from the targeting algorithm 128 includes information indicating a distance between the weapon system 100 and the target. The targeting algorithm 128 can determine the range, for example, using photogrammetry and object recognition. For example, the target model 110 can be trained to detect a particular class of tank, and can include information relating to a size of the particular class of tank. The targeting algorithm 128 can use the target model 110 to detect an object, classify the object as the particular class of tank, and determine a relative size of the tank within the field of view (e.g., field of view 450). The relative size of the tank within the field of view can be indicated, for example, by a number of pixels occupied by the tank within the field of view, by a percentage of the field of view that is occupied by the tank, or both. The targeting algorithm 128 can determine, based on the size of the particular class of tank, and the size of the tank within the field of view, an estimated distance between the weapon system and the target.

The process 150 includes providing the output data from the target model to a flight control system of the weapon system (160). In some examples, the process 150 includes determining an object location based on the output data from the target model, determining a weapon system location, and providing the object location and the weapon system location as input to a weapon system control model.

In some implementations, the targeting algorithm 128 outputs a relative location of the target within a field of view of a target sensor. In such implementation, the operating system can convert the output into data that is actionable by the flight control systems. In some examples, the relative location of the target within the field of view of the target sensor is represented by a coordinate location of the target within a frame of sensor data. The coordinate location can be a Cartesian coordinate location in units of pixels relative to a center of the sensor field of view. An example location is (−257,−333), indicating a location that is 257 pixels to the left of center and 333 pixels below center of the sensor field of view. The targeting algorithm 128 can convert the pixel coordinate location to a bearing and elevation of the target relative to the weapon system.

The targeting algorithm 128 can determine a bearing rate of change of the target by tracking the target over multiple frames of sensor data. For example, in a second frame of sensor data, the pixel coordinate position of the target can be (−253,−339). Therefore, the change in the target position between the first frame and the second frame is (+4,−6).

The targeting algorithm 128 can determine the location and motion of the target based on the bearing rate of change of the target and based on characteristics of the weapon system such as the weapon system direction, speed, sensor field of view angle, zoom setting, and/or other characteristics. Thus, the targeting algorithm 128 can output, to the flight control algorithm 126, the data that is actionable by the flight control systems such as the target bearing, range, elevation, direction of motion, speed, or any combination thereof.

In some examples, the process 150 includes obtaining weapon system control signals as output from the weapon system control model. The weapon system control signals cause movement of control components of the weapon system to maneuver the weapon system to the target location. For example, referring to FIG. 4A, the control signals can cause movement of control components in order to reduce and/or minimize the distance between the target 420 and the center cursor 421. Control components can include control surfaces such as wings, fins, rudders, ailerons, elevators, tails, stabilizers, foils. Control components can include propulsion components such as engines and thrusters.

The process 150 includes controlling operation of weapon system control surfaces responsive to the output data (162). Controlling the operation of the control surfaces controls the trajectory of the weapon system. Control surfaces can be operated, for example, by raising, lowering, tilting, turning the control surfaces.

In some examples, the amount of adjustment specified by the control signals varies based on the range to the target. For example, the flight control algorithm 126 can output control signals that cause larger adjustments (e.g., larger changes to control surface positions) when the target is a greater distance away from the weapon system 100, and can output control signals that cause smaller adjustments (e.g., smaller changes to control surface positions) when the target is nearer to the weapon system 100.

In some examples, the amount of adjustment specified by the control signals varies based on the relative positioning between the weapon system 100 and the target. For example, the flight control algorithm 126 can output control signals that cause larger adjustments (e.g., larger changes to control surface positions) when the target position within the field of view is farther away from the center of the field of view of the target sensor(s) 134, and can output control signals that cause smaller adjustments (e.g., smaller changes to control surface positions) when the target position within the field of view is nearer to the center of the field of view of the target sensor(s) 134.

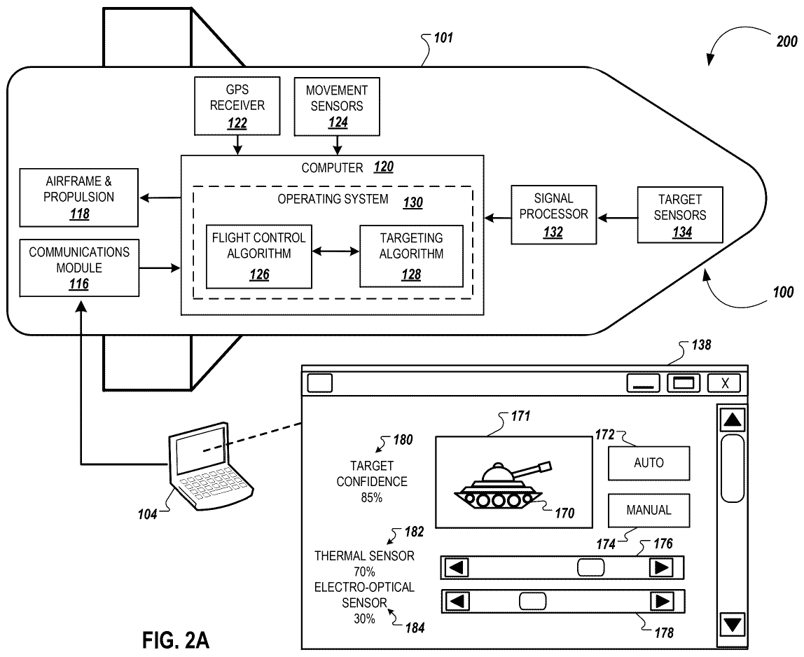

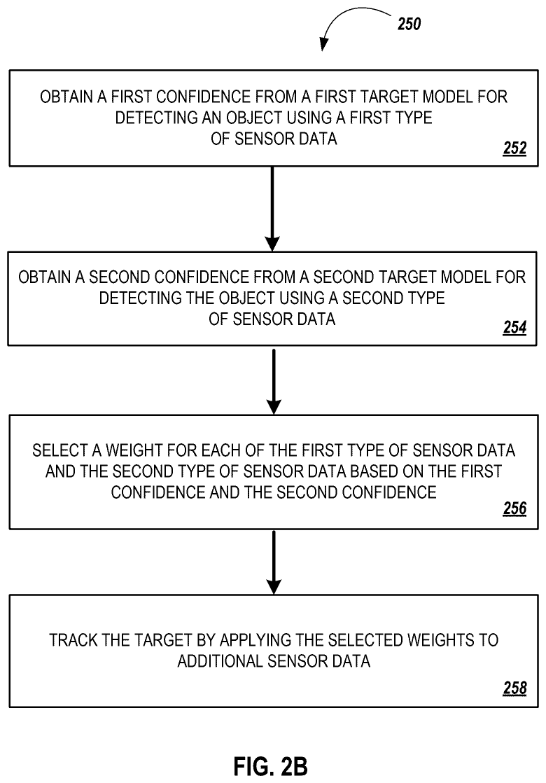

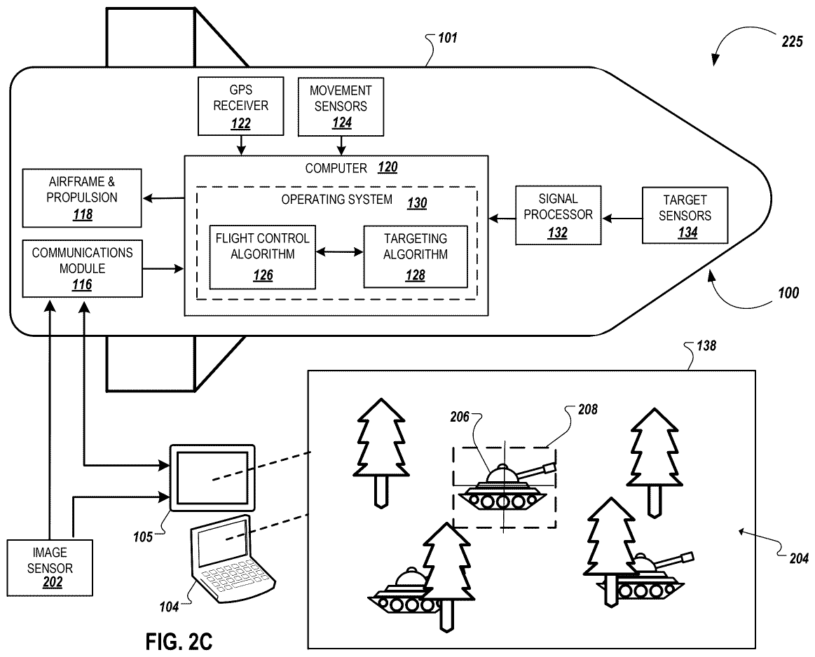

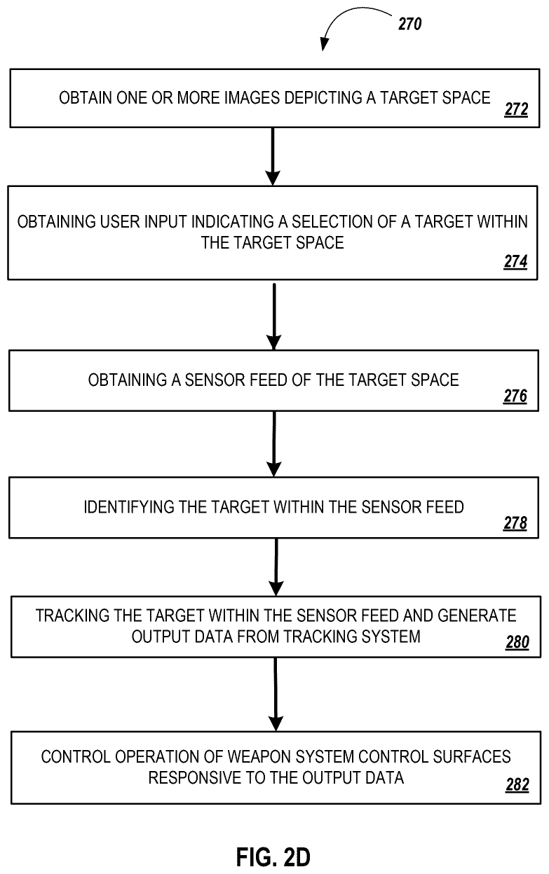

FIG. 2A is a diagram of an example system 200 for tracking targets using multiple sensors in accordance with implementations of the present disclosure. The system 200 includes the weapon system 100.

As described above with reference to FIG. 1A, the target model 110 can include multiple machine learning models. In some examples, the target model 110 includes multiple different machine learning models for multiple different types of sensors. The targeting algorithm 128 can use sensor fusion to be able to use more than one sensor at the same time. The targeting algorithm 128 can weight sensor data from the multiple sensors in order to obtain a combined target picture.

In some examples, the operating system 130 can autonomously determine that a first sensor is providing a higher confidence of target detection and tracking than a second sensor, and can apply a greater weight to sensor data from the first sensor than to sensor data from the second sensor. In some examples, the operating system 130 can receive user input that instructs the targeting algorithm 128 to apply a greater weight to one sensor and a lesser weight to another sensor.

The computing device 104 can present a user interface 138 showing a target 170 detected by the target sensors 134. The user interface 138 includes a selectable icon 172 for automatic sensor fusion and a selectable icon 174 for manual sensor fusion. In some examples, the computing device can be a viewfinder of a shoulder launched weapon system. In such examples, input may be provided by a controller (e.g., joystick or other electronic input device) on the shoulder launched weapon system.

When the selectable icon 172 is selected by a user, the targeting algorithm 128 autonomously determines weights to apply to the different types of sensor data. In an example, the targeting algorithm 128 can initially determine to apply fifty percent weight to thermal sensor data and fifty percent weight to the electro-optical sensor data, and can adjust the weights based on the confidence values output by the target model 110. For example, the target model 110 may output a higher confidence value for the thermal sensor data than for the electro-optical sensor data, and in response the targeting algorithm 128 can determine to apply a greater weight to the thermal sensor data than to the electro-optical sensor data. Referring to FIG. 2A, the user interface 138 shows that the targeting algorithm 128 applies a weight 182 of 70% to the thermal sensor data and a weight 184 of 30% to the electro-optical sensor data. In some examples, the targeting algorithm 128 selects weights for the different types of sensors in order to maximize the confidence level for detection of the target using the fused sensor data.

The user interface 138 shows the target 170 in a window 171. In some examples, the window 171 shows the target 170 and surrounding environment as depicted using the fused sensor data. For example, the image depicted in the window 171 can be generated using thermal sensor data, weighted at 70%, combined with electro-optical sensor data, weighted at 30%.

The user interface 138 shows a target confidence 180. The target confidence 180 can indicate a confidence level of detection and/or tracking of the target 170 using the sensor data weighted per the assigned weights. In the example of FIG. 2A, using the thermal sensor data weighted at 70% and the electro-optical sensor data weighted at 30%, the target confidence is 85%.

The user interface 138 includes selectable elements to enable a user to adjust sensor weights. In the example of FIG. 2A, the selectable elements include slide bar 176 for the thermal sensor data and slide bar 178 for the electro-optical sensor data.

When the selectable icon 174 is selected by a user, the weights applied to the different types of sensor data can be manually input by a user. For example, the user can provide input using the slide bars 176, 178 in order to adjust the weights applied to the thermal sensor data and to the electro-optical sensor data. The user may adjust the weights, for example, in order to view images of the target 170 in the window 171 at various different weights. For example, the user can adjust the weights to 100% thermal sensor data and 0% electro-optical sensor data in order to view the target 170 as detected by only the thermal sensor. The user can adjust the weights to 0% thermal sensor data and 100% electro-optical sensor data in order to view the target 170 as detected by only the electro-optical sensor. The user can adjust the weights to 50% thermal sensor data and 50% electro-optical sensor data in order to view the target 170 as detected equally by both the thermal sensor and the electro-optical sensor.

In some examples, the weight balance between sensors can be set at a particular time, and remain constant until the weapon system 100 intercepts the target 170. For example, the targeting algorithm 128 can determine optimal weights of the sensor data during a launch or midcourse phase of deployment, and can lock the weights prior to a terminal guidance phase. The weight balance between the sensor data can then remain constant during the terminal guidance phase.

Although shown as using two different types of sensor data, the system 200 can use any number of different types of sensor data. For example, the targeting algorithm 128 can determine a weight balance between multiple different types of sensor data such as radar sensor data, infrared sensor data, imaging sensor data, visible light sensor data, lidar sensor data, ultraviolet sensor data, x-ray sensor data, audio sensor data, ultrasonic sensor data, and magnetic sensor data.

FIG. 2B is a flow diagram of an example process 250 for tracking targets using multiple sensors in accordance with implementations of the present disclosure. The process 250 can be performed by a computing system including one or more computers, such as the computer 120. The computer 120 can track targets using at least a first type of sensor data and a second type of sensor data.

The first type of sensor data and the second type of sensor data can each include sensor data generated by any type of target sensor 134. The target sensors 134 can include any combination of the following: thermal sensors, radar sensors, infrared sensors, imaging sensors, visible light sensors, lidar sensors, electro-optical sensors, ultraviolet sensors, x-ray sensors, microphones, acoustic transducers, ultrasonic sensors, magnetic sensors. In some examples, a target sensor 134 can be a combination sensor that fuses two or more different types of sensor data. For example, a target sensor 134 can be an electro-optic infrared sensor that uses a combination of optics and electronics to detect objects in the infrared spectrum.

In some examples, the first type of sensor data is generated by a first target sensor 134 of a weapon system, and the second type of sensor data is generated by a second target sensor 134 of the weapon system. For example, the first type of sensor data can be thermal sensor data generated by a thermal sensor, and the second type of sensor data can be electro-optical sensor data generated by an electro-optical sensor. A thermal sensor is a sensor that can detect objects that emit thermal signatures. An electro-optical sensor is an electronic detector that converts light, or a change in light, into an electronic signal.

The process 250 includes obtaining a first confidence from a first target model for detecting an object using a first type of sensor data (252). The first confidence can indicate a confidence of accuracy of the identity of the target determined using the first type of sensor data, a confidence of accuracy of the location of the target determined using the first type of sensor data, or any combination thereof. The first target model is configured to detect objects using the first type of sensor data. The first target model processes first sensor data of the first type of sensor data to output the first confidence. In an example scenario, a first confidence is a confidence of 60% for detecting a particular target using the first type of sensor data.

The process 250 includes obtaining a second confidence from a second target model for detecting the object using a second type of sensor data (254). The second confidence can indicate a confidence of accuracy of the identity of the target determined using the second type of sensor data, a confidence of accuracy of the location of the target determined using the second type of sensor data, or any combination thereof. The second target model is configured to detect objects using the second type of sensor data. The second target model processes second sensor data of the second type of sensor data to output the second confidence. In the example scenario, a second confidence is a confidence of 50% for detecting the particular target using the second type of sensor data.

The process 250 includes selecting a weight for each of the first sensor data and the second sensor data based on the first confidence and the second confidence (256). For example, the targeting algorithm 128 can select a first weight for the first type of sensor data and a second weight for the second type of sensor data. Referring to FIG. 2A, the first weight is 70% for thermal sensor data, and the second weight is 30% for electro-optical sensor data. In some examples, the targeting algorithm 128 selects a higher weight for sensor data having a higher confidence, and a lower weight for sensor data having a lower confidence.

The process 250 includes tracking the target by applying the selected weights to additional sensor data (258). For example, the targeting algorithm 128 can apply the first weight to additional sensor data of the first type of sensor data, and can apply the second weight to additional sensor data of the second type of sensor data.

In some examples, the process 250 includes guiding a weapon system to the object based on tracking the object. In some examples, the process 250 includes generating rendering data, that, when rendered by a computing device, causes the computing device to display a user interface including an image of the object. The image is generated using the first type of sensor data weighted by the first weight and the second type of sensor weight by the second weight. The process 250 can include providing the rendering data to the computing device.

In some examples, the user interface includes one or more user interface elements for providing user input to adjust the first weight and the second weight. For example, referring to FIG. 2A, the user interface 138 includes user interface elements 176, 178 for adjusting the first weight and the second weight.

In some examples, the process 250 includes receiving, through the user interface, user input. The user input can indicate an adjusted first weight for the first type of sensor data and/or an adjusted second weight for the second type of sensor data. The process 250 can include tracking the object by applying the adjusted first weight to the additional sensor data of the first type of sensor data and applying the adjusted second weight to the additional sensor data of the second type of sensor data.

In some examples, the process 250 includes generating an updated image of the object using the adjusted first weight for the first type of sensor data and the adjusted second weight for the second type of sensor data. For example, referring to FIG. 2A, the image in the window 171 can be updated to show the scene including the target 170 as depicted using the first type of sensor data and the second type of sensor data weighted by the respective adjusted weights.

FIG. 2C is a diagram of an example system for tracking targets using freeze frame target acquisition in accordance with implementations of the present disclosure. The system 225 includes the weapon system 100. Freeze frame target acquisition is a process for initially identifying and tracking a target. Freeze frame target acquisition permits a user to move from cover briefly and capture an image of the target space and select a target from undercover. Then when ready to launch the weapon, the user can point the weapon in a general direction of the target, without requiring precise aiming, and the weapon system will match the still image and the target selection to a video feed of the target space from the weapon system's own sensors. In some examples, the weapon system 100 will provide an indication once it acquires the selected target in the video feed to indicate that the user can launch the weapon system 100. The indication can be an audible or visual indication. In some examples, the user can launch the weapon system 100 before the weapon system has fully acquired the target (e.g., locked onto the target), and the weapon system 100 will acquire the selected target after launch.

Freeze frame target acquisition uses one or more still images of a target space to identify a target. Once a user selects a target in at least one of the still images, the target selection can be uploaded into the weapon system's targeting system 128. The targeting system uses the still image and target selection to detect the selected target within a video feed generated by the target sensors 134. Once a target is acquired the weapons system 100 can operate according other processes described herein.

The system 225 is generally similar to system 200. The system includes the weapon system 100, an image sensor 202, and a display device 105. The image sensor 202 can be an optical, infrared, or thermal camera system. The image sensor 202 is in communication with the weapon system 100 and/or with the display device 105 through a wired or wireless interface, e.g., through the communications module 116. The image sensor 202 can be, e.g., a digital viewfinder of a launcher for the weapon system 100, a hand held digital camera, or a camera mounted on an autonomous or semi-autonomous vehicle (e.g., an autonomous or remote controlled drone).

The display device 105 is in communication with the weapon system 100 and with the image sensor 202. The display device 105 is a computing device capable of rendering images on a display and receiving user input, e.g., through a touch screen or other input device. In some implementations, the image sensor 202 and display device 105 are parts of the same device, e.g., a viewfinder of a launcher for the weapon system 100. In some implementations, computing device 104 of system 100 can be used as the display device 105.

In operation, the user captures one or more still images of a target space 204 using the image sensor 202. The image sensor 202 transfers the captured images to the display device 105 on which they are presented to the user in a user interface 138. The display device 105 receives a user input indicating selection of a target. In some examples, the images are captured by the target sensors 134 of the weapon system and transferred to the display device 105.

For example, the display device 105 can be configure to receive touch input. The user may select a target 206 by dragging a box 208 or other graphical enclosure around the target 206. This will indicate to the display device a set of pixels within the image that are representative of the target 206. In such instances, the region of selected pixels can form the target selection data.

In other implementations, the display device 105 can be a computing device that is configured to execute targeting algorithms similar to the targeting algorithm of the weapon system 100. For example, the display device 105 can include or have access to target model 110. The one or more still images can be processed by the target model 110 to identify potential targets within the target space 204. The potential targets can be indicated on the display device 105, e.g., by being highlighted in a high-contrast color or using bounding boxes 208. In such implementations, the target model pre-selects the potential targets and a user input selection can be a selection of one of the pre identified potential targets.

In some implementations, the display device 105 can communicate with the targeting system of the weapon system 100 to identify potential targets. Rather than, or in addition to, the target model 110 being executed by the display device 105, the captured image(s) can be transmitted directly to the weapon system 100, and the targeting algorithm 128 can pre-identify the potential targets and transmit the captured still image(s) to the display device 105 with the pre-identified potential targets indicated.

In some implementations, the images include multiple types of images. For example, the image sensor 202 can be configured to capture optical, thermal, and infrared images, thereby, permitting a target to be identified using multiple sensor modalities. In such implementation, a user can select the target in whichever image type is easiest for the user to identify the image, but the user's selection can be propagated to each image type. For example, the image types can be layered similar to the red-green-blue layers of an RBG image, such that pixels of each image type generally correspond with one another in each layer. This may permit the targeting system to identify and track the target using the sensor feed from which every sensor type (e.g., optical, thermal, or infrared) provides the most accurate and/or reliable data based on the target type and/or environmental conditions.

Once a target selection is obtained, data identifying the target (e.g., a selection of a pre-identified potential target or a region of pixels within one or more still images) is transmitted to the weapon system 100. The still image(s) are also transferred to the weapon system 100, if not already done. When the weapon system 100 is ready to be launched, the targeting algorithm 128 analyzes a real-time sensor feed from the target sensors 134 to identify the selected target within the sensor feed. The senor feed can be, e.g., an optical video feed, an infrared video feed, and/or a thermal video feed. For example, the targeting algorithm 128 can process sensor feeds that correspond with the same sensor type as the still image(s). For example, if the target was selected from an optical image, the targeting algorithm targeting algorithm 128 can process an optical sensor feed to identify the target.

The targeting algorithm 128 uses the still image(s) and target selection data to identify the selected target 206 within the sensor feed of the target space 204. For example, the targeting algorithm 128 can use any of the target models 110 or algorithms described herein to identify the selected target within the sensor feed. Once the target is identified within the senor feed, the weapon system 100 can provide a target acquisition indication to the user. For example, the weapon system 100 can create an audible indication (e.g., a buzz or beep) or a visual indication (e.g., changing a color of a reticle or bounding box around the selected target on the display device 105) to indicate that the weapon system 100 is ready to be launched. After launch, the targeting algorithm 128 can track the target in the sensor feed and guide the weapon system 100 towards the selected target 206. For example, as discussed above, the targeting system employs targeting algorithm 128 to track the selected target 206 and communicates with the flight control system which employs flight control algorithm 126 to operate the weapon's control surfaces and guide the weapon system 100 to the target.

In some implementations, the weapon system can be launched before identifying the target within the sensor feed. In such implementation the weapon system 100 can process the sensor feed while in flight to identify (e.g., acquire) the selected target. Once identified, the targeting system 128 tracks the target and communicates with the flight control algorithm 126 to guide the weapon system 100 to the target.

In some implementations, the images include multiple types of images. For example, the image sensor 202 can be configured to capture optical, thermal, and infrared images, thereby, permitting a target to be identified using multiple sensor modalities. In such implementation, a user can select the target in whichever image type is easiest for the user to identify the image, but the user's selection can be propagated to each image type. For example, the image types can be layered similar to the red-green-blue layers of an RGB image, such that pixels of each image type generally correspond with one another in each layer. This permits the targeting system to identify and track the target using the sensor feed from which every sensor type (e.g., optical, thermal, or infrared) provides the most accurate and/or reliable data based on the target type and/or environmental conditions.

FIG. 2D is a flow diagram of an example process 270 for tracking targets using freeze frame target acquisition in accordance with implementations of the present disclosure. The process 270 can be performed by a computing system including one or more computers, such as the computer 120, computing device 104, and/or display device 105. Some of the steps of the process 270 can be performed prior to deployment (e.g., launch) of a weapon system. Some of the steps of the process 270 can be performed during a deployment of a weapon system, such as during a flight of an airborne weapon system.

The process 270 includes obtaining one or more images depicting a target space (272). For example, one or more still images of a target space can be captured by image sensor 202 or the target sensors 134 on the weapon system 100. The image(s) can be still images of the target space. The image(s) can include one or more types of image(s) including optical images, thermal images, and/or infrared images. The image(s) can be transmitted to the display device 104, e.g., if the image sensors 202 are separate from the display device 105. The display device 105 renders the image(s) on a display to the user.

In some implementations, the image(s) are input into a targeting AI model (e.g., targeting model 110) to pre-identify potential targets within the image(s). For instance, the image(s) can be processed by the targeting algorithm 128 of the weapon system 100 and/or by a similar targeting algorithm executed by computing device 104 or display device 105. In such implementation, data locating the pre-identified potential targets are also sent to the display device 105. The locating data can include meta data indicating pixel regions within each of the image(s) represent the pre-identified potential targets. The image(s) are the presented on the display device 105 with a graphical indication of the pre-identified potential targets.

The process 270 includes obtaining user input indicating a selection of a target within the target space depicted in the one or more image(s) (274). For example, the display device 105 receives user input indicating a target selection within a still image. In some implementations, the user may select a target 206 by dragging a box 208 or other graphical enclosure around the target 206. This will indicate to the display device a set of pixels within the image that are representative of the target 206. In such instances, the region of selected pixels can form the target selection data. In implementations where the images include pre-identified potential targets, a user input selection can be a selection of one of the pre identified potential targets.

Once the target selection is obtained, the target selection data is provided to the weapon system 100. For example, the target selection data can be transmitted to the targeting system of the weapons system 100. If the image(s) have not yet been transferred to the weapon system 100, they are also transmitted with the target selection data to the weapon system 100.

The process 270 includes obtaining a sensor feed of the target space (276). For example, a sensor feed can be obtained by the target sensors 134 of the targeting system within the weapon system 100. The sensor feed can be a real-time feed or stream of sensor data from the target sensors 134, e.g., optical video, thermal video, infrared video, or a combination thereof. The sensor feed is passed to the targeting algorithm 128 to identify the selected target within the sensor feed.

The process 270 includes identifying the target within the sensor feed (278). For example, the weapon's targeting system can employ the targeting algorithm 128 to identify the user's selected target within the sensor feed based on the target selection data and the one or more image(s). For example, the targeting system can match characteristics of the selected target within a still image of the target space with characteristics of objects present in the sensor feed. Using an optical image and sensor feed as an example, the weapon's targeting system can perform an image analysis by comparing the region of pixels that represents the user selected target in the still image to identify a region of pixels within the sensor feed representing an object with similar characteristics. In some implementations, the targeting system employs an AI targeting model, e.g., targeting model 110 to identify the selected target within the sensor feed.

The process 270 includes tracking the target within the sensor feed and generating output data from the targeting system (280). Before or after the weapon system 100 is deployed, the weapon system 100 begins tracking the user selected target within the sensor feed from target sensors 134. The weapons system 100 continues to track the user selected target within he sensor feed during flight. For example, the weapon system's targeting system can employ the targeting algorithm 128, as discussed herein, to track the target in the video feed and generate output data that is usable by the weapon's flight control system to control the trajectory of the weapon system 100.

The process 270 includes controlling operation of the weapon system control surfaces responsive to the output data (282). For example, while tracking the selected target the targeting algorithm generates output data that can be passed to a flight control system to guide the trajectory of the weapon system 100. For example, the targeting algorithm 128 can track the target in the sensor feed and guide the weapon system 100 towards the selected target 206.. For example, as discussed above, the targeting system employs targeting algorithm 128 to track the selected target 206 and communicates with the flight control system which employs flight control algorithm 126 to operate the weapon's control surfaces and guide the weapon system 100 to the target.

FIG. 3A is a diagram of an example system 300 for terminal effect control of a weapon system in accordance with implementations of the present disclosure. The system 300 includes the weapon system 100.

The weapon system 100 can receive external input 302. The external input 302 can include the targeting package 114, as described above with reference to FIG. 1A. The targeting package 114 includes the weapon system control model 108, the weapon system metadata 112, and the target model 310.

The external input 302 can include user input 304. The user input 304 can be provided by a user through a computing device such as the computing device 104. The weapon system 100 receives the external input 302 through the communications module 116 over one or more wired or wireless networks.

The weapon system control model 108 includes a launch control model 320, a midcourse control model 330, and a terminal control model 340. The launch control model 320 guides the weapon system 100 during a launch phase of deployment. During the launch phase, the weapon system 100 is initialized, launched from its launching platform, and boosted to travel speed. Inertial guidance may be used to establish an initial flight path to intercept the target. The initial flight path may be predetermined prior to launch.

The midcourse control model 330 guides the weapon system 100 during a midcourse phase of deployment, during which the weapon system 100 moves toward the target. During the midcourse phase, the weapon system 100 tracks the target and moves towards the target.

The terminal control model 340 guides the weapon system 100 during a terminal phase of deployment, during which the weapon system 100 approaches the target, intercepts the target, activates a payload, or any combination of these. In some implementations, the terminal control model 340 is incorporated with the targeting model 110. In some examples, the terminal phase begins tens of seconds before intercept. In some examples, the terminal phase begins a few seconds before intercept. The purpose of the terminal phase is to remove the residual errors accumulated during the prior phases and, ultimately, to reduce the final distance between the interceptor and target below a specified threshold distance.

During the terminal phase of flight, the guided weapon system must have a high degree of accuracy and a quick reaction capability. Moreover, near the very end of the terminal phase, the guided weapon system may maneuver to maximum capability in order to converge on and hit a fast-moving, evasive target. For weapon systems that employ a warhead, the final miss distance should be less than the warhead's lethal radius in order to achieve a successful engagement. A direct-hit weapon can tolerate only very small miss distances relative to a selected aimpoint on the target body.

The weapon system 100 can enter terminal phase in response to approaching within a specified distance to the target. The specified distance can vary based on the type of weapon system, the type of target, or both. In some examples, the target data 312 output by the targeting algorithm 128 includes an estimated distance between the weapon system 100 and the target. The estimated distance can be determined, for example, using a range-finding sensor and/or using photogrammetry processes. The terminal control model 340 can take over operations of the weapon system 100 when the weapon system 100 is within the specified distance to the target, as determined using the estimated distance.

The flight control algorithm 126 uses the terminal control model 340 of the weapon system control model 108 to generate control signals during the terminal phase. The terminal control model 340 can autonomously select an approach to the target. The approach can include a speed and/or angle of attack. For example, the weapon system 100 can approach the target from above, below, and/or to the side. In some examples, the terminal control model 340 selects an approach to the target based on identifying one or more aspects of the target that are prioritized for damage. In some examples, the aspects that are prioritized for damage can be defined by the target model 110.

The terminal control model 340 can autonomously select a type of payload for engaging the target. In some examples, the weapon system 100 includes multiple different types of payloads. The terminal control model 340 can select a type of payload based on the target data 312 from the targeting algorithm 128. Types of payloads can include conventional explosive warheads, chemical warheads, biological warheads, nuclear warheads, blast warheads, fragmentation warheads, shaped charge warheads, anti-armor warheads, continuous-rod warheads, thermal warheads, pyrotechnic warheads, chaff warheads, cluster-bomb units, anti-personnel warheads, multi-mode warheads, or any combination thereof. In some examples, the payload includes multiple submunitions that provide for multiple engagements from a single weapon system.

In some examples, the weapon system 100 includes non-warhead payloads. For example, the weapon system 100 can be used for humanitarian assistance to deliver food and other supplies. In an example, a weapon system 100 carries a payload including a bundle of food connected to a parachute. The terminal control model 340 can autonomously select an approach to a target destination and can select a timing of launching the payload in order to deliver the bundle of food to the target destination.

The terminal control model 340 can select a timing of activating the payload. The terminal control model 340 can select the timing based on the target data 312 and based on the type of payload selected. For example, the terminal control model 340 can determine to activate, or detonate, a first type of payload (e.g., a fragmentation warhead) prior to intercepting the target. The terminal control model 340 can determine to activate a second type of payload (e.g., a conventional explosive warhead) upon intercept.

In some examples, the target data 312 indicates a location of the target relative to the weapon system, an aspect of the target that is facing the weapon system 100, or both. The terminal control model 340 can select the approach and/or the payload activation based on the target data 312 received from the targeting algorithm 128. In an example scenario, the target is a ship. The target data 312 can indicate that the location of the target is 30 degrees off of the nose of the weapon system. The target data 312 can indicate that the aspect of the target facing the weapon system is the bow of the ship. The terminal control model 340 can select an approach to the ship based on the relative location of the target, based on the aspect of the target facing the weapon system, or any combination thereof. The terminal control model 340 can also select a type of payload, and a timing of activating the payload, based on the relative location of the target and/or based on the aspect of the target facing the weapon system.

In some examples, the weapon system 100 includes more than one projectile. The terminal control model 340 can autonomously determine to launch multiple projectiles in response to determining that the target has reactive armor. The terminal control model 340 can select to launch the multiple projectiles sequentially or in tandem. After a first projectile detonates the reactive armor, a following projectile is more likely to damage the target. The multiple projectiles can include shaped charge projectiles, kinetic energy penetrator projectiles, or any combination thereof.

In some examples, the weapon system 100 includes countermeasures such as jammers and chaff. Chaff is a decoy countermeasure that uses metallic strips or wire lengths to flood a target's radar system with false signals. Jammers can interfere with enemy communications, radars, and weapons systems. The terminal control model 340 can autonomously determine to activate one or more countermeasures, for example, in response to determining that the target is tracking the weapon system 100. In some examples, the terminal control model 340 selects to activate countermeasures prior to activating another payload such as an explosive payload.

FIG. 3B is a flow diagram of an example process 350 for terminal effect control of a weapon system in accordance with implementations of the present disclosure. The process 350 can be performed by a computing system including one or more computers, such as the computer 120.

The process 350 includes obtaining priority data indicating a priority of target aspects (352). The priority data can indicate a priority of each of multiple different aspects of the target. In some examples, an aspect of the target is a component of the target (e.g., a wheel of a vehicle, a gun of a tank, a bridge of a ship). An aspect of the target can be a side of the target (e.g., a front of a vehicle, a right side of a tank, a starboard side of a ship).

The priority data can indicate a ranking of importance of the target aspects. For example, for a target that is a tank, the priority data can indicate a ranking, from highest priority to lowest priority, of: track idler, main drive sprocket, glacis plate, driver's hatch, cupola, turret, gun mantlet. For a target that is a ship, example priority data can indicate a ranking, from highest priority to lowest priority, of: engine room, rudder, bridge, mast.

The process 350 includes providing weapon system sensor data to a target model (354). The target model (e.g., the target model 110) is AI model that trained to identify multiple different aspects of a particular type of object within a set of sensor data from one or more types of sensors. The target model 110 is trained to provide output that is decipherable by flight control systems to control navigation operations. The weapon system sensor data can include sensor data generated by the target sensors 134 (not shown in FIG. 3A).

The process 350 includes obtaining aspect data as output from the target model (356). The aspect data indicates a detection of at least one aspect of the target and data indicating a relative location of the aspect on the target.

The process 350 includes selecting a particular aspect of the target (358). For example, the targeting algorithm 128 can select a first aspect of the target based on the priority data and the aspect data. For example, the targeting algorithm 128 can select, from a set of aspects of the target that are visible to the target sensors 134, a first aspect that has the highest priority as specified by the priority data. The first aspect can be, for example, a bridge of a ship.

The process 350 includes determining whether the particular aspect is already damaged (360). For example, after obtaining the aspect data indicating the detection of the first aspect of the target, the targeting algorithm 128 can determine, based on the sensor data, a damage evaluation of the first aspect of the target. For example, the targeting algorithm 128 can determine whether the bridge of the ship has already been damaged.

In some examples, the targeting algorithm 128 can evaluate a level of damage that has been done to the particular aspect and can compare the level of damage to a threshold level of damage. In response to determining that the level of damage is less than the threshold level of damage, the targeting algorithm can determine that the particular aspect is not already damaged.

The process 350 includes, in response to determining that the particular aspect is not already damaged, generating control signals to guide the weapon system to the first aspect (362). For example, the weapon system control model 108 can generate control signals 306 to adjust the airframe and propulsion 118 to cause the weapon system 100 to move towards the first aspect of the target (e.g., the bridge of the ship).

The targeting algorithm 128 can evaluate a level of damage that has been done to the particular aspect and can compare the level of damage to a threshold level of damage. In response to determining that the level of damage is greater than the threshold level of damage, the targeting algorithm can determine that the particular aspect is already damaged.

The process 350 includes, in response to determining that the first aspect is already damaged, selecting a different particular aspect of the target (358). For example, after selecting the first aspect of the target, the targeting algorithm 128 can obtain additional sensor data from the target sensors 134 and can determine, based on the additional sensor data, that the first aspect of the target is already damaged. The targeting algorithm 128 can then select a different, second aspect of the target based on the damage evaluation of the first aspect of the target. The weapon system control model 108 can generate second control signals to guide the weapon system to the second aspect of the target.

In some examples, the targeting algorithm 128 can detect armor at one or more aspects of the target. The targeting algorithm 128 can select a particular aspect of the target based on the armor detected at the one or more aspects of the target. For example, the targeting algorithm 128 can select an aspect at which armor is not detected over an aspect at which armor is detected, even when the aspect at which armor is detected has a higher priority.

In some examples, the targeting algorithm 128 can detect armor at the first aspect of the target after selecting the first aspect of the target. The targeting algorithm 128 can select a different, second aspect of the target based on the detection of armor at the first aspect. The weapon system control model 108 can generate second control signals to guide the weapon system to the second aspect of the target.

In some examples, the operating system 130 receives user input 304 indicating a particular aspect of the target. The targeting algorithm 128 can detect and track the particular aspect of the target in response to receiving the user input. In some examples, the user input 304 overrides the autonomously selected aspect. For example, the targeting algorithm 128 may select to target a bridge of a ship. The user input 304 can indicate a selection of an engine room of the ship. The user input 304 can override the autonomous selection such that the operating system 130 moves the weapon system 100 to intercept the engine room instead of the bridge.

In some examples, the process 350 is performed when the weapon system 100 is within a threshold distance to the target. The threshold distance can be determined based on a type of the target, a type of the weapon system, or both. For example, the threshold distance can be a greater distance for a faster moving target and/or a faster moving weapon system. The threshold distance can be a smaller distance for a slower moving target and/or a slower moving weapon system. The targeting algorithm 128 can determine the threshold distance based on the weapon system control model 108, the weapon system metadata 112, and the target model 110.

FIGS. 4A to 4D show example stages of a process for target tracking recovery including adjusting target sensors. FIGS. 4A to 4D each show a field of view 450 of a target sensor 134 of a weapon system 100 at a different time.

Referring to FIG. 4A, the weapon system 100 detects a target 420. The target 420 is positioned at a center 424 of the field of view 450. FIG. 4A shows a range line 422 representing a particular distance from the center 424 of the field of view 450.

Referring to FIG. 4B, the weapon system 100 loses acquisition of the target 420 such that the target sensor 134 no longer detects the target 420. Therefore, the target 420 does not appear in the field of view 450 in FIG. 4B. The weapon system 100 can lose acquisition of the target 420 due to, for example, an object passing between the weapon system 100 and the target 420, environmental effects such as fog, clouds, and sand, the target 420 making an abrupt change in its trajectory, sensor jamming, or any combination of these.

Responsive to losing acquisition of the target 420, the weapon system 100 estimates a location of the target 420 and searches for the target 420 at the estimated location. The estimated location can include, for example, an estimated distance from the location of the target 420 prior to losing the acquisition of the target 430. In some examples, the estimated location includes an estimated direction relative to the location of the target prior to losing the acquisition of the target 420. In some examples, the estimated location includes a geographic region defined by a border.

In some examples, after losing acquisition of the target 420, the weapon system 100 searches for the target 420 by adjusting the field of view 450 of the target sensor 134. For example, the weapon system can adjust the field of view of the target sensor 134 by zooming in, zooming out, panning, tilting, or any combination thereof. In the example of FIG. 4C, the weapon system zooms out the target sensor such that the field of view 450 shows a larger area compared to FIG. 4B. Thus, the range line 422 appears smaller in FIG. 4C than in FIG. 4D.

Referring to FIG. 4C, the target 420 is detected in the field of view 450 after the target sensor adjusts its field of view by zooming out. The target sensor can output sensor data representing the target 420 to the targeting algorithm 128 which determines whether the target 420 is the same as the target that was previously tracked in FIG. 4A. Processes for identifying previously tracked targets are described in greater detail with reference to FIG. 4I.

Referring to FIG. 4D, the weapon system 100 resumes tracking the target 420 in response to determining that the target 420 is the same as the target that was previously tracked. The target sensor 134 adjusts its field of view (e.g., by panning and/or tilting) such that the target 420 is once again positioned at the center 424 of the field of view 450.

FIGS. 4E to 4H show example stages of a process for target tracking recovery including selectively searching sensor data. FIGS. 4E to 4H each show a plot of a geographic region 460 in which the weapon system 100 tracks a target 430 using target sensors 134 at a different time.

Referring to FIG. 4E, the weapon system 100 tracks the target 430. The target 430 is at an initial position 440. The target 430 travels along a trajectory represented by vector 434.

Referring to FIG. 4F, the weapon system 100 loses acquisition of the target 430 such that the target sensor 134 no longer detects the target 430. Therefore, the target 430 does not appear in the geographic region 460 in FIG. 4F.

Responsive to losing acquisition of the target 430, the weapon system 100 estimates a location of the target 430 and searches for the target 430 at the estimated location. The estimated location can include, for example, an estimated distance from the initial position 440 of the target 430 prior to losing the acquisition of the target 430. In some examples, the estimated location includes an estimated direction relative to the initial position 440. In some examples, the estimated location includes a geographic region defined by a border.

In some examples, after losing acquisition of the target 430, the weapon system 100 searches for the target 430 by searching subsets of sensor data generated by the target sensors 134. For example, referring to FIG. 4G, the weapon system 100 can search a subset of sensor data representing objects detected within a geographic region defined by boundaries 444a, 444b. By searching for the target 430 in a subset of sensor data instead of searching all collected sensor data, the weapon system 100 can reacquire the target 430 more quickly and with reduced processing power.

The estimated position of the target and/or the boundaries 444a can be determined by a dead reckoning process based on the initial position 440 of the target 430 and the trajectory 434 of the target 430. Dead reckoning is the process of calculating the current position of a moving object by using a previously determined position, and incorporating estimates of speed, heading (or direction or course), and elapsed time.

The estimated position of the target and/or the boundaries 444a can be determined by a state estimator that is a linear quadratic estimator, such as a Kalman filter. In some cases, the targeting algorithm 128 uses a combination of a hidden Markov model and continuous latent variable estimation (such as an extended Kalman filter, unscented Kalman filter). A Kalman filtering process can be performed based on the initial position 440 of the target 430 and the trajectory 434 of the target 430. Kalman filtering, also known as linear quadratic estimation, is an algorithm that uses a series of measurements observed over time, including statistical noise and other inaccuracies, and produces estimates of unknown variables that tend to be more accurate than those based on a single measurement alone, by estimating a joint probability distribution over the variables for each timeframe.

Referring to FIG. 4G, the weapon system 100 determines estimated positions 431, 432, 433 of the target 430 at multiple different times t1, t2, t3, respectively. The weapon system 100 determines the estimated positions 431, 432, 433 based on the initial position 440 and the trajectory 434. Each estimated position is associated with an uncertainty range represented in FIG. 4G by circles 441, 442, 443. For example, circle 441 represents an uncertainty range for the estimated position 431 at time t1, circle 442 represents an uncertainty range for the estimated position 432 at time t2, and circle 443 represents an uncertainty range for the estimated position 433 at time t3.

The boundaries 444a, 444b intersect the initial position 440 of the target 430 and the circumferences of the circles 441, 442, 443. In an example in which the target 430 is restricted to traveling on a surface (e.g., a truck, a tank, a ship), the boundaries 444a, 444b can define a two-dimensional region such as a triangle. In an example in which the target 430 is maneuverable in free space (e.g., an aircraft, a spacecraft, a submarine), the boundaries 444a, 444b can define a three-dimensional region such as a cone.

In some examples, the subset of sensor data searched by the weapon system 100 changes over time. For example, the subset of sensor data can represent a geographic area that increases in size over time. In an example, at time t1 the weapon system 100 can search sensor data representing a geographic region defined by boundary 444a, boundary 444b, and tangent 451 to the circle 441. At time t2 the weapon system 100 can search sensor data representing a geographic region defined by boundary 444a, boundary 444b, and tangent 452 to the circle 442. At time t3 the weapon system 100 can search sensor data representing a geographic region defined by boundary 444a, boundary 444b, and tangent 453 to the circle 443.

Referring to FIG. 4H, the target 430 is detected at position 456 after the weapon system searches the subsets of sensor data representing geographic locations between the boundaries 444a, 444b. The target sensor can output sensor data representing the target 430 to the targeting algorithm 128 which determines whether the target 430 is the same as the target that was previously tracked in FIG. 4E. Processes for identifying previously tracked targets are described in greater detail with reference to FIG. 4I.

The weapon system 100 can resume tracking the target 430 in response to determining that the target 430 is the same as the target that was previously tracked.

FIG. 4I is a flow diagram of an example process 400 for target tracking recovery in accordance with implementations of the present disclosure. The process 400 can be performed by a computing system including one or more computers, such as the computer 120.

The process 400 includes tracking a target using sensor data generated by weapon system sensors (402). For example, the weapon system 100 can track the target 420 using sensor data generated by the target sensors 134 that are mounted on the weapon system.

The process 400 includes performing actions responsive to losing acquisition of the target (404). In some examples, the weapon system determines that the acquisition of the target is lost based on determining that the target is no longer detectable in the sensor data.

The actions include determining an estimated location of the target (406). For example, the weapon system 100 can determine the estimated location of the target based on prior tracking data. The prior tracking data can include, for example, the target's previous location, speed, direction, acceleration, turn rate, or any combination of these. In some examples, the weapon system 100 determines the estimated location of the target based on a time at which the target was lost, a present time, and a characteristic of the target. The characteristic of the target can include, for example: a speed of the target during tracking of the target, a direction of movement of the target during tracking of the target, a turn rate of the target during tracking of the target, a speed capability of the target, a maneuverability of the target, a turn radius of the target, an altitude or depth capability of the target, or any combination of these.

In some examples, the estimated location is a geographic area defined by boundaries. In some examples, the estimated location includes a distance and/or direction relative to a center of a target sensor's field of view. In some examples, the weapon system 100 can determine the estimated location of the target using dead reckoning processes. In some examples, the weapon system 100 can determine the estimated location of the target using Kalman filtering processes.

The process 400 includes controlling navigation of the weapon system based on the estimated location (408). For example, after losing acquisition of the target, and before re-acquiring the target, the weapon system control model 108 can generate control signals 306 that cause the weapon system to travel towards the estimated location.

The process 400 includes searching within the estimated location of the target to re-acquire the target (410). For example, referring to FIG. 4C, the weapon system can search the estimated location by steering one or more target sensors towards the estimated location. In some examples, the weapon system searches the estimated location by adjusting a field of view of a target sensor, such as by tilting, panning, and/or zooming.

In some examples, the estimated location of the target includes a region of the field of view of the sensors. The size of the region can change over time based on the present time and the at least one characteristic of the target. For example, the region of the field of view of a sensor can be a region of pixels within the field of view. The region of pixels can change (e.g., expand) over time after losing acquisition of the target.

The process 400 includes detecting an object within the estimated location (412). For example, referring to FIG. 4H, the weapon system detects an object at the position 456 in between the boundaries 444a, 444b.

The process 400 includes determining whether the detected object is the target (414). In some examples, determining whether the detected object is the target includes providing data representing the detected object as input to a target re-acquisition model, and obtaining output data from the target re-acquisition model. The output data from the target re-acquisition model can indicate whether the detected object is the target. In some examples, the output from the target re-acquisition model indicates a likelihood that the detected object is the target. In some examples, the target re-acquisition model is part of the targeting algorithm 128.

In some examples, the target re-acquisition model is configured to re-acquire a target based on comparing features of objects detected in sensor data with features of the target. The features can include, for example, colors of the object, shapes of the object, a size of the object, and the presence or absence of components of the object.

The process 400 includes, in response to determining that the detected object is the target, tracking the target using the sensor data generated by the weapon system sensors (402). For example, referring to FIG. 4H, the weapon system can resume tracking the target 430 after locating the target 430.

The process 400 optionally includes, in response to determining that the detected object is not the target, searching the estimated location to re-acquire the target (410). For example, referring to FIG. 4H, the weapon system may determine that the object detected at the position 456 is not the target 430, and in response, continue searching the subset of sensor data representing objects detected in the geographic region between the boundaries 444a, 444b.

The process 400 optionally includes, in response to determining that the detected object is not the target, determining an updated estimated location of the target. For example, referring to FIG. 4H, the weapon system may determine that the object detected at the position 456 is not the target 430, and in response, determine an updated estimated location of the target. The updated estimated location of the target may include a larger geographic area than was previously searched, such as a geographic area that includes regions farther away from the initial position 440 than the position 456 and/or a geographic area that includes regions outside the boundaries 444a, 444b.

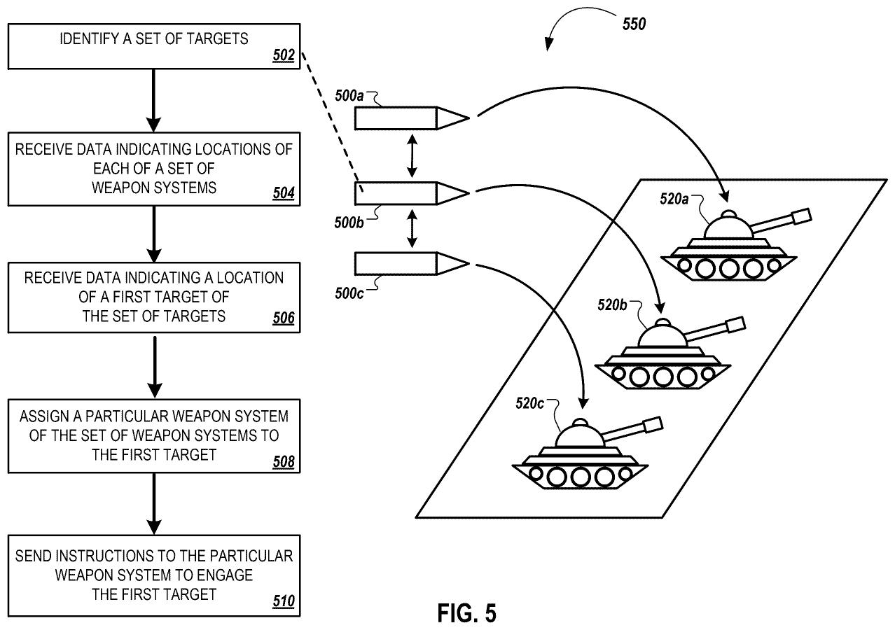

FIG. 5 is a flow diagram of an example process 550 for assigning multiple weapon systems to multiple targets in accordance with implementations of the present disclosure. The process 550 can be performed by a computing system including one or more computers, such as the computer 120.

FIG. 5 shows a set of weapon systems includes weapon system 500a, weapon system 500b, weapon system 500c (“weapon systems 500”). In some examples, the process 550 is performed by a computer 120 of one of the weapon systems 500. For example, the process 550 can be performed by a computer of the weapon system 500b. In some examples, the process 550 is performed by a computer of a lead weapon system of a set of weapon systems. The lead weapon system can be designated before detection of targets, or can be designated after detection of targets.

The weapon systems 500 can communicate with each other using wireless or wire-based swarm communications. The communications can be one-way communications (e.g., from the lead weapon system to the other weapon systems) or two-way communications (e.g., between the lead weapon system and the other weapon systems). Wireless communications can include, for example, radio frequency communications, visible light communications, non-visible light communications, acoustic communications, or any combination of these.

The process 550 includes identifying a set of targets (502). The set of targets includes target 520a, target 520b, and target 520c. In some examples, the set of targets are identified before deployment of the set of weapon systems. For example, target models for each of the targets 520a, target 520b, and target 520c can be uploaded to one or more of the weapon systems prior to launch.

The process 550 includes receiving data indicating locations of each of a set of weapon systems (504). For example, the computer of the weapon system 500b can receive data indication locations of the weapon system 500a, the weapon system 500b, and the weapon system 500c. In some examples, the data indicating the locations of the set of weapon systems is received by wired communication. In some examples, the data indicating the locations of the set of weapon systems is received by wireless communication. In some examples, the data indicating the locations of the weapon systems includes GPS data. In some examples, the data indicating the locations of the weapon systems includes information indicating positions of the weapon systems relative to the lead weapon system 500b. For example, the weapon system 500c can send, to the weapon system 500b, information indicating a range, bearing, and/or elevation between the weapon system 500c and the weapon system 500b.

In some examples, the set of weapon systems are deployed from a same platform. The platform can be, for example, a ship, an aircraft, or a land-based launching platform. The data indicating the locations of each of the set of weapon systems can be received after the set of weapon systems are deployed from the platform.

The process 550 includes receiving data indicating a location of a first target of the set of targets (506). The first target can be, for example, the target 520a. In some examples, the computer 120 receives the data indicating the location of the first target from another weapon system. For example, the computer 120 of the weapon system 500b can receive the data indicating the location of the target 520a from the weapon system 500a. In some examples, the data indicating the locations of the first target includes information indicating a position of the first target relative to the weapon system that detected the target. For example, the weapon system 500a can send, to the weapon system 500b, information indicating a range, bearing, and/or elevation between the weapon system 500a and the target 520a.

The process 550 includes assigning a particular weapon system of the set of weapon systems to the first target (508). The lead weapon system 500b can assign individual weapon systems to different targets. The lead weapon system 500b can send instructions over the wireless or wired communication networks that cause the weapon systems to engage the assigned targets. In some examples, one weapon system is assigned to each target. In some examples, multiple weapon systems are assigned to a same target. For example, in response to detecting reactive armor on a target, the lead weapon system 500b can assign multiple weapon systems to engage the target at sequential times, such that the first weapon system triggers the reactive armor and the second weapon system damages the target.

In some examples, the particular weapon is selected based on the location of the first target and the locations of each weapon system of the set of weapon systems. For example, the weapon system 500b can select a weapon system that is nearest to the target and has not yet been assigned to another target. In some examples, the weapon system 500b can select a weapon system based on capabilities of the weapon system. For example, the weapon system 500b can select a particular weapon system that has an anti-tank warhead for engaging a tank, and can select a different weapon system that has an anti-personnel warhead for engaging personnel.

In some examples, the particular weapon system is the weapon system that detected the target. For an example in which the weapon system 500b receives data indicating the location of the target 520a from the weapon system 500a, the weapon system 500b may assign the weapon system 500a to the target 520a.

In some examples, the particular weapon system is a weapon system that is different from the weapon system that detected the target. For an example in which the weapon system 500b receives data indicating the location of the target 520a from the weapon system 500a, the weapon system 500b may assign the weapon system 500c to the target 520a.

The process 550 includes sending instructions to the particular weapon system to engage the first target (510). In some examples, the particular weapon system is connected to the lead weapon system 500b by a communication wire. The lead weapon system 500b can send the instructions to the particular weapon system over the communication wire. In some examples, the particular weapon system is configured to detach from the communication wire after receiving the instructions.

In some examples, after the lead weapon system 500b sends the instructions to the weapon systems, the lead weapon system 500b sends an additional instruction that causes the weapon systems to separate from each other. In an example in which the communications are wire-based, each weapon system can detach from the wire in response to receiving the separation instruction.

The process 550 can include receiving data indicating updated locations of each weapon system of the set of weapon systems, receiving data indicating a location of a second target, and selecting another particular weapon system to engage the second target. In some examples, the particular weapon system is selected based on the location of the second target and the updated locations of each weapon system of the set of weapon systems.

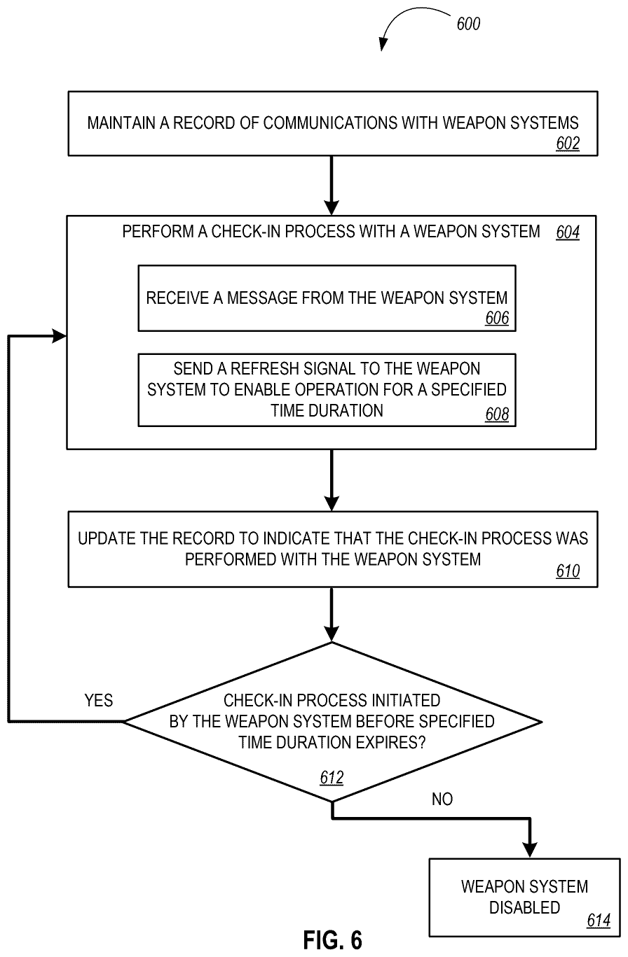

FIG. 6 is a flow diagram of an example process 600 for safeguarding weapon systems in accordance with implementations of the present disclosure. The weapons systems can be safeguarded such that the operating system is required to be revalidated periodically (e.g., weekly, monthly, semi-monthly) in order to continue operating. Revalidation can include renewing an operating license with a key code.

The process 600 includes maintaining a record of communications with weapon systems (602). The record can be maintained by one or more computers in a database. In some examples, the database is a distributed database. In some examples, the database is a Blockchain ledger that registers communications with weapon systems and updates made to weapon systems. The record can include a record of communication between the one or more computers and the weapon systems. In some examples, the record includes multiple entries. Each entry corresponds to a weapon system and indicates a time at which the check-in process was performed.

The process 600 includes performing a check-in process with a weapon system (604). The check-in process can be performed with the weapon system at a first time. In some examples, the check-in process can only be performed with a computing system that satisfies a set of requirements. The set of requirements can include a location of the computing system, a security classification of the computing system, an encryption capability of the computing system, or any combination of these.

The check-in process includes receiving a message from the weapon system (606). In some examples, the message includes a code, and the check-in process includes authenticating the message using the code. In some examples, the process 600 includes, in response to receiving the message from the weapon system, sending a software update package to the weapon system.

The check-in process includes sending a refresh signal to the weapon system to enable operation for a specified time duration (608). The refresh signal can be sent in response to receiving the message from the weapon system. The refresh signal enables an operating system of the weapon system to operate for a specified time duration. The specified time duration can be, for example, a specified number of days, a specified number of weeks, or a specified number of months.

The process 600 includes updating the record to indicate that the check-in process was performed with the weapon system (610). The record can be updated to indicate that the check-in process was performed at the first time.

The process 600 includes determining whether a check-in process is initiated by the weapon system before the specified time duration expires (612). In some examples, the process 600 includes determining that the specified time duration has expired after the first time, and determining that the weapon system has not initiated the check-in process since the first time.

The process 600 includes, in response to determining that the check-in process was initiated by the weapon system before the specified time duration expires, repeating the check-in process with the weapon system (604).

The process 600 includes, in response to determining that the check-in process was not initiated by the weapon system before the specified time duration expires, disabling the weapon system (614). For example, the process 600 can include determining that the specified time duration has expired after the first time, and that the first weapon system has not initiated the check-in process with the one or more computers since the first time. In response, the process 600 can include sending a signal to the weapon system to disable the operating system of the first weapon system, sending a signal to the weapon system to activate an alarm on the weapon system, generating a notification for presentation to a user, or any combination thereof. In some examples, when the specified time duration expires, the weapon system disables itself. For example, the operating system 130 can disable itself when a timer expires. Performing the check-in process can reset the timer.

In some examples, disabling the weapon system includes deleting the operating system 130 and/or parts of the operating system 130. For example, the deletion can include deleting configuration files, machine learning models, metadata, and algorithms stored by the operating system or run on the operating system. In some examples, when the specified time duration expires, the weapon system deletes the operation system and/or part of the operating system 130. For example, the operating system can auto-delete when a timer expires. Performing the check-in process can reset the timer.

Although the disclosed inventive concepts include those defined in the attached claims, it should be understood that the inventive concepts can also be defined in accordance with the following embodiments.

In addition to the embodiments of the attached claims and the embodiments described above, the following numbered embodiments are also innovative.

Embodiment 1 is a weapon system including: a weapon system body; a targeting system housed within the body and including: one or more target sensors, a targeting control system in electrical communication with the one or more target sensors, and a data store in electrical communication with the targeting control system and storing a target model including an artificial intelligence (AI) model trained to detect a particular type of object within a set of sensor data from one or more particular types of sensors and to provide output data that is decipherable by flight control systems; a flight system housed within the body and in communication with the targeting system, the flight control system including: a plurality of controllers mechanically coupled to a plurality of control surfaces, and a flight control system in electrical communication with the controllers. The targeting control system is configured to perform targeting operations including: obtaining sensor data from the target sensors, providing the sensor data as input to the target model and, in response, obtaining output data from the target model, and providing the output data to the flight control system. The flight control system is configured to perform flight operations including controlling operation of the control surfaces responsive to the output data to control a trajectory of the weapon system.

Embodiment 2 is a method including actions of: obtaining sensor data from one or more sensors mounted to a weapon system; providing the sensor data as input to a target model, the target model being an artificial intelligence (AI) model trained to detect a particular type of object within a set of sensor data from one or more particular types of sensors and to provide output that is decipherable by flight control systems to control navigation operations; obtaining output data from the target model; providing the output data from the target model to a flight control system of the weapon system; and controlling operation of one or more control surfaces of the weapon system, responsive to the output data to control a trajectory of the weapon system.

Embodiment 3 is the method of embodiment 2, wherein the output data from the target model includes navigation instructions indicating a location of an object relative to a location or an orientation of the weapon system.

Embodiment 4 is the method of any one of embodiments 2 or 3, wherein the output of the target model includes a confidence value indicating a confidence that an object within the sensor data is the particular type of object.

Embodiment 5 is the method of any one of embodiments 2 through 4, comprising: obtaining first sensor data from a first sensor; obtaining second sensor data from a second sensor; assigning a first weight to the first sensor data; and assigning a second weight to the second sensor data. The target model is configured to determine the confidence value using the first sensor data weighted by the first weight and the second sensor data weighted by the second weight.

Embodiment 6 is the method of any one of embodiments 2 through 5, comprising: determining an object location based on the output data; determining a weapon system location; providing the object location and the weapon system location as input to a weapon system control model; and obtaining weapon system control signals as output from the weapon system control model. The weapon system control signals cause movement of control components of the weapon system to maneuver the weapon system to the target location.

Embodiment 7 is the method of any one of embodiments 2 through 6, wherein the weapon system control model includes an AI model that is trained to determine control surface operations to maneuver the weapon system to the target based on the target location and the weapon system location.

Embodiment 8 is the method of any one of embodiments 2 through 7, wherein the weapon system includes one of a missile, a torpedo, or a bomb.

Embodiment 9 is a method comprising: processing, with a first target model that is configured to detect objects using a first type of sensor data, first sensor data of the first type of sensor data; processing, with a second target model that is configured to detect objects using a second type of sensor data, second sensor data of the second type of sensor data; obtaining, as output from the first target model, a first confidence for detection of an object using the first type of sensor data; obtaining, as output from the second target model, a second confidence for detecting the object using the second type of sensor data; selecting, based on the first confidence and the second confidence, a first weight for the first type of sensor data and a second weight for the second type of sensor data; tracking the object by applying the first weight to additional sensor data of the first type of sensor data and applying the second weight to additional sensor data of the second type of sensor data.

Embodiment 10 is the method of embodiment 9, comprising guiding a weapon system to the object based on tracking the object.

Embodiment 11 is the method of any one of embodiments 9 or 10, wherein the first type of sensor data is generated by a first sensor of a weapon system; and the second type of sensor data is generated by a second sensor of the weapon system.

Embodiment 12 is the method of any one of embodiments 9 through 11, wherein the first type of sensor data includes thermal sensor data, and the second type of sensor data includes electro-optical sensor data.

Embodiment 13 is the method of any one of embodiments 9 through 12, comprising generating rendering data, that, when rendered by a computing device, causes the computing device to display a user interface including an image of the object. The image is generated using the first type of sensor data weighted by the first weight and the second type of sensor weight by the second weight. The actions include providing the rendering data to the computing device.

Embodiment 14 is the method of any one of embodiments 9 through 13, the user interface includes one or more user interface elements for providing user input to adjust the first weight and the second weight.

Embodiment 15 is the method of any one of embodiments 9 through 14, comprising receiving, through the user interface, user input indicating at least one of: an adjusted first weight for the first type of sensor data; or an adjusted second weight for the second type of sensor data; and tracking the object by applying the adjusted first weight to the additional sensor data of the first type of sensor data and applying the adjusted second weight to the additional sensor data of the second type of sensor data.

Embodiment 16 is the method of any one of embodiments 9 through 15, comprising generating an updated image of the object using the adjusted first weight for the first type of sensor data and the adjusted second weight for the second type of sensor data.

Embodiment 17 is a method comprising: obtaining a target model, the target model being an artificial intelligence (AI) model trained to identify multiple different aspects of a particular type of object within a set of sensor data from one or more particular types of sensors and to provide output that is decipherable by flight control systems to control navigation operations; obtaining priority data indicating a priority of each of the multiple different aspects of the target; obtaining sensor data from at least one sensor of a weapon system; providing the sensor data as input to the target model; obtaining, as output from the target model, aspect data indicating a detection of at least one aspect of a target and data indicating a relative location of the aspect on the target; selecting, from the at least one aspect of the target, a first aspect of the target based on the priority data and the aspect data; and generating first control signals to guide the weapon system to the first aspect of the target.

Embodiment 18 is the method of embodiment 17, comprising: after obtaining the aspect data indicating the detection of the at least one aspect of the target, determining, based on the sensor data, a damage evaluation of the at least one aspect of the target; and selecting the first aspect of the target based at least in part on the damage evaluation of the at least one aspect of the target.

Embodiment 19 is the method of any one of embodiments 17 or 18, comprising: after selecting the first aspect of the target, receiving user input indicating a different, second aspect of the target; and generating second control signals to guide the weapon system to the second aspect of the target.

Embodiment 20 is the method of any one of embodiments 17 through 19, comprising: after obtaining the aspect data indicating the detection of the at least one aspect of the target, detecting, based on the sensor data, armor at one or more of the at least one aspect of the target; and selecting the first aspect of the target based at least in part on the armor detected at the one or more of the at least one aspect of the target.

Embodiment 21 is the method of any one of embodiments 17 through 20, comprising: after selecting the first aspect of the target, obtaining additional sensor data from the at least one sensor of the weapon system; determining, based on the additional sensor data, a damage evaluation of the first aspect of the target; selecting, from the at least one aspect of the target, a different, second aspect of the target based on the damage evaluation of the first aspect of the target; and generating second control signals to guide the weapon system to the second aspect of the target.

Embodiment 22 is the method of any one of embodiments 17 through 21, comprising: after selecting the first aspect of the target, obtaining additional sensor data from the at least one sensor of the weapon system; detecting, based on the additional sensor data, armor at the first aspect of the target; selecting, from the at least one aspect of the target, a different, second aspect of the target based on the detection of armor at the first aspect of the target; and generating second control signals to guide the weapon system to the second aspect of the target.

Embodiment 23 is the method of any one of embodiments 17 through 22, wherein the method is performed when the weapon system is within a threshold distance to the target.

Embodiment 24 is the method of any one of embodiments 17 through 23, comprising determining the threshold distance to the target based at least in part on a type of the target indicated by the target model.

Embodiment 25 is the method of any one of embodiments 17 through 24, comprising determining the threshold distance to the target based at least in part on a type of the weapon system indicated by a weapon system control model.

Embodiment 26 is a method comprising: tracking a target using sensor data generated by sensors mounted on a weapon system; and responsive to losing acquisition of the target: determining, based on prior tracking data of the target, an estimated location of the target; controlling navigation of the weapon system based on the estimated location; and searching within the estimated location of the target to re-acquire the target.

Embodiment 27 is the method of embodiment 26, comprising determining that the acquisition of the target is lost based on determining that the target is no longer detectable in the sensor data.

Embodiment 28 is the method of any one of embodiments 26 or 27, comprising:
detecting an object within the estimated location; and determining whether the detected object comprises the target.

Embodiment 29 is the method of any one of embodiments 26 through 28, wherein determining whether the detected object comprises the target comprises: providing data representing the detected object as input to a target re-acquisition model; and obtaining output data from the target re-acquisition model that indicates whether the detected object comprises the target.

Embodiment 30 is the method of any one of embodiments 26 through 29, wherein the target re-acquisition model is configured to re-acquire a target based on comparing features of objects detected in sensor data with features of the target.

Embodiment 31 is the method of any one of embodiments 26 through 30, comprising, in response to determining that the detected object comprises the target, tracking the target using additional sensor data generated by the sensors.

Embodiment 32 is the method of any one of embodiments 26 through 31, comprising, in response to determining that the detected object does not comprise the target, continuing to search the sensor data to re-acquire the target.

Embodiment 33 is the method of any one of embodiments 26 through 32, comprising determining whether the detected object comprises the target based on a relative position of the object relative to other objects represented by the sensor data.

Embodiment 34 is the method of any one of embodiments 26 through 33, comprising: determining the estimated location of the target based on a time at which the target was lost, a present time, and at least one characteristic of the target.

Embodiment 35 is the method of any one of embodiments 26 through 34, wherein the at least one characteristic of the target comprises one or more of: a speed of the target during tracking of the target, a direction of movement of the target during tracking of the target, a speed capability of the target, and a maneuverability of the target.

Embodiment 36 is the method of any one of embodiments 26 through 35, wherein the estimated location of the target comprises a region of a field of view of the sensors, and a size of the region changes over time based on the present time and the at least one characteristic of the target.

Embodiment 37 is the method of any one of embodiments 26 through 36, wherein determining, based on the prior tracking data of the target, the estimated location of the target comprises determining the estimated location using Kalman filtering processes.

Embodiment 38 is the method of any one of embodiments 26 through 37, wherein searching within the estimated location of the target to re-acquire the target comprises searching a region of the sensor data that corresponds to the estimated location of the target.

Embodiment 39 is the method of any one of embodiments 26 through 38, wherein searching within the estimated location of the target to re-acquire the target comprises steering one or more of the sensors towards the estimated location of the target.

Embodiment 40 is a method comprising: receiving information identifying a set of targets; receiving data indicating locations of each of a set of weapon systems; receiving, from a first weapon system of the set of weapon systems, data indicating a location of a first target of the set of targets; selecting, based on the location of the first target and the locations of each weapon system of the set of weapon systems, a particular weapon system of the set of weapon systems to assign to the first target; and sending instructions to the particular weapon system to engage the first target.

Embodiment 41 is the method of embodiment 40, wherein the particular weapon system comprises the first weapon system.

Embodiment 42 is the method of any one of embodiments 40 or 41, wherein the particular weapon system is a different weapon system from the first weapon system.

Embodiment 43 is the method of any one of embodiments 40 through 42, comprising: receiving data indicating updated locations of each weapon system of the set of weapon systems; receiving, from a second weapon system of the set of weapon systems, data indicating a location of a second target of the set of targets; and selecting, based on the location of the second target and the updated locations of each weapon system of the set of weapon systems, another particular weapon system to engage the second target.

Embodiment 44 is the method of any one of embodiments 40 through 43, wherein the method is performed by a computer of a lead weapon system of the set of weapon systems.

Embodiment 45 is the method of any one of embodiments 40 through 44, wherein the data indicating the locations of the set of weapon systems is received by wired communication.

Embodiment 46 is the method of any one of embodiments 40 through 45, wherein the data indicating the locations of the set of weapon systems is received by wireless communication.

Embodiment 47 is the method of any one of embodiments 40 through 46, wherein: the set of weapon systems are deployed from a same platform; and the data indicating the locations of each of the set of weapon systems is received after the set of weapon systems are deployed.

Embodiment 48 is the method of any one of embodiments 40 through 47, wherein: the method is performed by a lead weapon system of the set of weapon systems; the particular weapon system is connected to the lead weapon system by a communication wire, wherein sending the instructions to the particular weapon system comprises sending the instructions to the particular weapon system over the communication wire; and the particular weapon system is configured to detach from the communication wire after receiving the instructions.

Embodiment 49 is a weapon system comprising: a weapon system body; a targeting system housed within the body and comprising: one or more sensors, a targeting control system in electrical communication with the one or more sensors, and a data store in electrical communication with the targeting control system and storing a target model comprising an artificial intelligence (AI) model trained to detect a particular type of object within a set of sensor data from one or more particular types of sensors and to provide output data that is decipherable by flight control systems; and a flight system housed within the body and in communication with the targeting system, the flight control system comprising: a plurality of controllers mechanically coupled to a plurality of control surfaces, and a flight control system in electrical communication with the controllers, wherein the targeting control system is configured to perform the method of any one of embodiments 2 through 48.

Embodiment 50 is a non-transitory computer readable storage medium having stored thereon processor-executable software instructions configured to cause a processor to perform the method of any one of embodiments 2 through 48.

Embodiment 51 is system, comprising: at least one processor; and a data store coupled to the at least one processor having instructions stored thereon which, when executed by the at least one processor, causes the at least one processor to perform the method of any one of embodiments 2 through 48.

Embodiment 52 is a method performed by one or more computers, comprising: maintaining, by the one or more computers and in a database, a record of communications between the one or more computers and each of a plurality of weapon systems; performing, by the one or more computers, a check-in process with a first weapon system of the plurality of weapon systems at a first time, including: receiving a message from the first weapon system; and in response to receiving the message from the first weapon system, sending a refresh signal to the first weapon system, wherein the refresh signal enables an operating system of the first weapon system to operate for a specified time duration; and updating, by the one or more computers, the record to indicate that the one or more computers performed the check-in process with the first weapon system at the first time.

Embodiment 53 is the method of embodiment 52, wherein the database comprises a distributed database.

Embodiment 54 is the method of any one of embodiments 52 or 53, wherein the message received from the first weapon system includes a code, and the check-in process comprises authenticating the message using the code.

Embodiment 55 is the method of any one of embodiments 52 through 54, comprising: determining that the specified time duration has expired after the first time; and determining that the first weapon system has not initiated the check-in process with the one or more computers since the first time.

Embodiment 56 is the method of any one of embodiments 52 through 55, comprising: in response to determining that the specified time duration has expired after the first time and that the first weapon system has not initiated the check-in process with the one or more computers since the first time, sending a signal to the first weapon system to disable the operating system of the first weapon system.

Embodiment 57 is the method of any one of embodiments 52 through 56, comprising: in response to determining that the specified time duration has expired after the first time and that the first weapon system has not initiated the check-in process with the one or more computers since the first time, sending a signal to the first weapon system to activate an alarm on the first weapon system.

Embodiment 58 is the method of any one of embodiments 52 through 57 comprising: in response to determining that the specified time duration has expired after the first time and that the first weapon system has not initiated the check-in process with the one or more computers since the first time, generating a notification for presentation to a user.

Embodiment 59 is the method of any one of embodiments 52 through 58, wherein the check-in process includes: in response to receiving the message from the first weapon system, sending a software update package to the first weapon system.

Embodiment 60 is the method of any one of embodiments 52 through 59, wherein the record includes a plurality of entries, wherein each entry: corresponds to a weapon system of the plurality of weapon systems, and indicates a time at which the one or more computers performed the check-in process with the corresponding weapon system.

Embodiment 61 is a non-transitory computer readable storage medium having stored thereon processor-executable software instructions configured to cause a processor to perform the method of any one of embodiments 52 through 60.

Embodiment 62 is a system, comprising: at least one processor; and a data store coupled to the at least one processor having instructions stored thereon which, when executed by the at least one processor, causes the at least one processor to perform the method of any one of embodiments 52 through 60.

Embodiment 63 is a guided weapon system comprising: a weapons system body; a targeting system housed within the body and comprising: one or more target sensors, a targeting control system in electrical communication with the one or more target sensors, a flight control system housed within the body and in communication with the targeting system, the flight control system comprising: a plurality of controllers mechanically coupled to a plurality of control surfaces, and a flight control system in electrical communication with the controllers; and a power system comprising one or more capacitors housed within the body and configured to supply electrical power to the targeting system and the flight control system through a regulated power bus, the one or more capacitors electrically connected to a charging terminal on the body. Embodiment 63 can be combined with any of the prior embodiments.

Embodiment 64 is the guided weapons system of embodiment 63, wherein the power system comprises a buck/boost converter connected between the charging terminal and the one or more capacitors.

Embodiment 65 is the guided weapons system of any one of embodiments 63 or 64, wherein the one or more capacitors comprise one or more super capacitors.

Embodiment 66 is the guided weapons system of any one of embodiments 63-65, further comprising a charging system configured to convert input voltage from an external power source to an operating voltage of the power system.

Embodiment 67 is the guided weapons system of any one of embodiments 63-66, wherein the targeting system comprises a data store in electrical communication with the targeting control system and storing a target model comprising an artificial intelligence (AI) model trained to detect a particular type of object within a set of measurement data from one or more particular types of sensors and to provide output data that is decipherable by flight control systems.

Embodiment 68 is the guided weapons system of any one of embodiments 63-67, wherein the targeting control system is configured to perform targeting operations comprising: obtaining sensor data from the target sensors, providing the sensor data as input to the target model and, in response, obtaining output data from the target model, and providing the output data to the flight control system, wherein the flight control system is configured to perform flight operations comprising controlling operation of the control surfaces responsive to the output data to control a trajectory of the weapon system.

Embodiment 69 is a guided weapon system targeting method comprising: obtaining, from an image sensor, one or more images depicting a target space; presenting the one or more images on a display device that is in communication with a weapon system; obtaining user input indicating a selection of a target within the target space depicted in the one or more images; providing the one or more images and the user input to a targeting system of the weapon system; obtaining, by the targeting system, a video feed of the target space; identifying, by the targeting system, the target within the video feed based on the one or more images and the user input; after weapon launch, tracking, by the target system, the target within the video feed; and generating, by the target system, output data that, when received by a flight control system of the weapon system, causes the flight control system to operate control surfaces of the weapon system to control a trajectory of the weapon system towards the target. Embodiment 69 can be combined with any of the prior embodiments.

Embodiment 70 is the guided weapons system of claim 69, further comprising responsive to identifying the target within the video feed, providing an indication that the targeting system is locked onto the target.

Embodiment 71 is the guided weapons system of any one of claims 69 or 70, further comprising providing the video feed for display on the display device.

Embodiment 72 is the guided weapons system of any one of claims 69-71, wherein the one or more images comprise at least one of an optical image, a thermal image, or an infrared image.

Embodiment 73 is the guided weapons system of any one of claims 69-72, wherein identifying the target within the video feed comprises providing the one or more images, the user input, and the video feed as input to a target model, the target model being an artificial intelligence (AI) model trained to detect a particular type of object within a set of sensor data from one or more particular types of sensors and to provide output that is decipherable by flight control systems to control navigation operations.

Embodiment 74 is the guided weapons system of claim 73, wherein the output data from the target model comprises navigation instructions indicating a location of an object relative to a location or an orientation of the weapon system.

Embodiment 75 is the guided weapons system of any one of claims 69-74, wherein the image sensor is mounted to a drone.

Embodiment 76 is the guided weapons system of any one of claims 69-75, wherein the image sensor is a target sensor within the weapon system.

Embodiment 77 is the guided weapons system of any one of claims 69-76, wherein the display device is a viewfinder of a shoulder launcher for the weapon system.

Embodiment 78 is a non-transitory computer readable storage medium having stored thereon processor-executable software instructions configured to cause a processor to perform the method of any one of embodiments 69 to 77.

Embodiment 79 is a system, comprising: at least one processor; and a data store coupled to the at least one processor having instructions stored thereon which, when executed by the at least one processor, causes the at least one processor to perform the method of any one of embodiments 69 to 77.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a flight controller, weapon operating system, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., touch screen, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations, and it should be understood that the described program components and systems can generally be integrated together in a single software product or packaged into multiple software products.

As used herein, the term “real time” refers to transmitting or processing data without intentional delay given the processing limitations of a system, the time required to accurately obtain data, and the rate of change of the data. In some examples, “real time” is used to describe receiving image data or targeting data from a sensor. For example, “real time” sensor data may be received from an image sensor and presented in a visual display (e.g., a view finder) as the images are being recorded by the sensor. Although there may be some actual delays, the delays are generally imperceptible to a user.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A weapon system comprising:
a weapon system body;
a targeting system housed within the weapon system body and comprising:
one or more target sensors,
a targeting control system in electrical communication with the one or more target sensors, and
a data store in electrical communication with the targeting control system and storing a target model comprising an artificial intelligence (AI) model trained to detect a particular type of object within a set of sensor data from one or more particular types of sensors and to provide output data that is decipherable by flight control systems; and
a flight control system housed within the body and in communication with the targeting system, the flight control system comprising: a plurality of controllers mechanically coupled to a plurality of control surfaces, wherein the flight control system is in electrical communication with the controllers; and
a power system comprising one or more capacitors housed within the body and configured to supply electrical power to the targeting system and the flight control system through a regulated power bus, the one or more capacitors electrically connected to a charging terminal on the body,
wherein the targeting control system is configured to perform targeting operations comprising:
obtaining sensor data from the target sensors,
providing the sensor data as input to the target model and, in response, obtaining output data from the target model, and
providing the output data to the flight control system, and
wherein the flight control system is configured to perform flight operations comprising controlling operation of the control surfaces responsive to the output data to control a trajectory of the weapon system.

2. The weapon system of claim 1, wherein the targeting operations further comprise:
obtaining, from an image sensor, one or more images depicting a target space;
providing the one or more images to a display device that is in communication with a weapon system;
obtaining user input indicating a selection of a target within the target space depicted in the one or more images;
providing the one or more images and the user input to a targeting system of the weapon system;
obtaining a video feed of the target space;
identifying the target within the video feed based on the one or more images and the user input;
after weapon launch, tracking, by the target system, the target within the video feed; and
generating output data that, when received by a flight control system of the weapon system, causes the flight control system to operate control surfaces of the weapon system to control a trajectory of the weapon system towards the target.

3. The weapon system of claim 1, wherein the targeting operations further comprise:
tracking a target using sensor data generated by the one or more sensors; and
responsive to losing acquisition of the target:
determining, based on prior tracking data of the target, an estimated location of the target;
controlling navigation of the weapon system based on the estimated location; and
searching within the estimated location of the target to re-acquire the target.

4. A guided weapon system comprising:
a weapons system body;
a targeting system housed within the body and comprising: one or more target sensors, a targeting control system in electrical communication with the one or more target sensors,
a flight control system housed within the body and in communication with the targeting system, the flight control system comprising: a plurality of controllers mechanically coupled to a plurality of control surfaces, and a flight control system in electrical communication with the controllers; and
a power system comprising one or more capacitors housed within the body and configured to supply electrical power to the targeting system and the flight control system through a regulated power bus, the one or more capacitors electrically connected to a charging terminal on the body.

5. The guided weapons system of claim 4, wherein the power system comprises a buck/boost converter connected between the charging terminal and the one or more capacitors.

6. The guided weapons system of claim 4, wherein the one or more capacitors comprise one or more super capacitors.

7. The guided weapons system of claim 4, further comprising a charging system configured to convert input voltage from an external power source to an operating voltage of the power system.

8. The guided weapons system of claim 4, wherein the targeting system comprises a data store in electrical communication with the targeting control system and storing a target model comprising an artificial intelligence (AI) model trained to detect a particular type of object within a set of measurement data from one or more particular types of sensors and to provide output data that is decipherable by flight control systems.

9. The guided weapons system of claim 8, wherein the targeting control system is configured to perform targeting operations comprising:
obtaining sensor data from the target sensors,
providing the sensor data as input to the target model and, in response, obtaining output data from the target model, and
providing the output data to the flight control system, and
wherein the flight control system is configured to perform flight operations comprising controlling operation of the control surfaces responsive to the output data to control a trajectory of the weapon system.

10. The guided weapons system of claim 4, wherein the weapon system comprises one of a missile, a torpedo, or a bomb.

11. The weapon system of claim 9, wherein the targeting operations further comprise:
obtaining, from an image sensor, one or more images depicting a target space;
providing the one or more images to a display device that is in communication with a weapon system;
obtaining user input indicating a selection of a target within the target space depicted in the one or more images;
providing the one or more images and the user input to a targeting system of the weapon system;
obtaining a video feed of the target space;
identifying the target within the video feed based on the one or more images and the user input;
after weapon launch, tracking, by the target system, the target within the video feed; and
generating output data that, when received by a flight control system of the weapon system, causes the flight control system to operate control surfaces of the weapon system to control a trajectory of the weapon system towards the target.

12. The weapon system of claim 9, wherein the targeting operations further comprise:
processing, with a first target model that is configured to detect objects using a first type of sensor data, first sensor data of the first type of sensor data;
processing, with a second target model that is configured to detect objects using a second type of sensor data, second sensor data of the second type of sensor data;
obtaining, as output from the first target model, a first confidence for detection of an object using the first type of sensor data;
obtaining, as output from the second target model, a second confidence for detecting the object using the second type of sensor data;
selecting, based on the first confidence and the second confidence, a first weight for the first type of sensor data and a second weight for the second type of sensor data; and
tracking the object by applying the first weight to additional sensor data of the first type of sensor data and applying the second weight to additional sensor data of the second type of sensor data.

13. The weapon system of claim 12, wherein the first type of sensor data comprises thermal sensor data and the second type of sensor data comprises electro-optical sensor data.

14. The weapon system of claim 9, wherein the targeting operations further comprise:
tracking a target using sensor data generated by the one or more sensors; and
responsive to losing acquisition of the target:
determining, based on prior tracking data of the target, an estimated location of the target;
controlling navigation of the weapon system based on the estimated location; and
searching within the estimated location of the target to re-acquire the target.

15. The weapon system of claim 14, wherein the targeting operations further comprise determining that the acquisition of the target is lost based on determining that the target is no longer detectable in the sensor data.

16. The weapon system of claim 14, wherein the targeting operations further comprise:
detecting an object within the estimated location; and
determining whether the detected object is the target.

17. The weapon system of claim 16, wherein determining whether the detected object is the target comprises:
providing data representing the detected object as input to a target re-acquisition model; and
obtaining output data from the target re-acquisition model that indicates whether the detected object comprises the target.

18. The weapon system of claim 14, wherein the targeting operations further comprise:
determining the estimated location of the target based on a time at which the target was lost, a present time, and at least one characteristic of the target, and
wherein the at least one characteristic of the target comprises one or more of: a speed of the target during tracking of the target, a direction of movement of the target during tracking of the target, a speed capability of the target, and a maneuverability of the target.

19. The weapon system of claim 14, wherein the estimated location of the target comprises a region of a field of view of the sensors, and a size of the region changes over time based on a present time and the at least one characteristic of the target.

20. A guided weapon system targeting method comprising:
obtaining, from an image sensor, one or more images depicting a target space, wherein the one or more images comprise at least one of an optical image, a thermal image, or an infrared image;
presenting the one or more images on a display device that is in communication with a weapon system;
obtaining user input indicating a selection of a target within the target space depicted in the one or more images;
providing the one or more images and the user input to a targeting system of the weapon system;
obtaining, by the targeting system, a video feed of the target space;
identifying, by the targeting system, the target within the video feed based on the one or more images and the user input;
after weapon launch, tracking, by the target system, the target within the video feed; and
generating, by the target system, output data that, when received by a flight control system of the weapon system, causes the flight control system to operate control surfaces of the weapon system to control a trajectory of the weapon system towards the target.

21. The guided weapons targeting method of claim 20, further comprising responsive to identifying the target within the video feed, providing an indication that the targeting system is locked onto the target.

22. The guided weapons targeting method of claim 20, wherein the image sensor is mounted to a drone, and
wherein the display device is a viewfinder of a shoulder launcher for the weapon system.
